(19) United States
(12) Patent Application Publication
(10) Pub. No.: US 2021/0377074 A1
(43) Pub. Date: Dec. 2, 2021

(54) DETECTION DEVICE, GATEWAY DEVICE, DETECTION METHOD, AND DETECTION PROGRAM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventors: Keigo YOSHIDA, Osaka-shi (JP); Yoshihiro HAMADA, Osaka-shi (JP); Hiroshi UEDA, Yokkaichi-shi (JP); Naoki ADACHI, Yokkaichi-shi (JP); Shinichi AIBA, Yokkaichi-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 17/284,505

(22) PCT Filed: Sep. 3, 2019
(86) PCT No.: PCT/JP2019/034553

§ 371 Date: Apr. 12, 2021

(30) Foreign Application Priority Data
Oct. 26, 2018 (JP) 2018-201835

(51) Int. Cl. H04L 12/40

(52) U.S. Cl. CPC H04L 12/40104; H04L 12/40195; H04L 2012/40273; H04L 12/40071; H04L 2012/40215; H04L 12/40065

(57) ABSTRACT

An abnormality in an on-vehicle network is accurately detected through a simple process. A detection device is configured to detect an abnormality in an on-vehicle network including a plurality of on-vehicle devices, and includes: a monitoring unit configured to monitor transmission messages in the on-vehicle network, and acquire a communication load in the on-vehicle network; an acquisition unit configured to acquire a history of a communication load in an on-vehicle network to which the detection device belongs, or another on-vehicle network; and a detection unit configured to detect an abnormality in the on-vehicle network, based on the history acquired by the acquisition unit and on the communication load acquired by the monitoring unit at a first timing after the history.

### TECHNICAL FIELD

The present invention relates to a detection device, a gateway device, a detection method, and a detection program.

This application claims priority on Japanese Patent Application No. 2018-201835 filed on Oct. 26, 2018, the entire content of which is incorporated herein by reference.

### BACKGROUND ART

PATENT LITERATURE 1 (Japanese Laid-Open Patent Publication No. 2017-126978) discloses an abnormality detection device as follows. That is, in an on-vehicle network system including a plurality of electronic control units that exchange a message via a bus in a vehicle according to a CAN (Controller Area Network) protocol, this abnormality detection device is connected to the bus and detects an abnormality. The abnormality detection device includes: a reception unit that receives a message from the bus; a determination unit that determines a unit time period; a specification unit that specifies feature information based on the number of messages received by the reception unit within the unit time period determined by the determination unit; and a judgement unit that judges whether or not there is an abnormality according to a result of an arithmetic process using the feature information specified by the specification unit and a predetermined model representing a reference for a message occurrence frequency.

Meanwhile, for example, PATENT LITERATURE 2 (Japanese Laid-Open Patent Publication No. 2017-85663) discloses a security device as follows. That is, this security device is connected to a plurality of electronic control units that exchange a frame according to a CAN protocol via one or a plurality of buses. The frame is a data frame including an ID field for storing an ID, a DLC (Data Length Code), and a data field. The security device includes: a reception unit that receives a frame from one of the buses; a holding unit that holds a data inspection parameter related to an inspection of a value of data stored in the data field, the data inspection parameter defining an inspection content regarding the frame; an update unit that performs a determination regarding a transmission cycle that is a time interval in which two frames having the same ID are transmitted, and that updates the data inspection parameter held by the holding unit, upon determining that a condition related to the frame received by the reception unit is satisfied when the reception interval of the two frames having the same ID is outside a predetermined allowable range; and an inspection unit that performs an inspection related to determination as to whether or not the frame received by the reception unit is an attack frame, based on the data inspection parameter held by the holding unit.

### CITATION LIST

### Patent Literature

PATENT LITERATURE 1: Japanese Laid-Open Patent Publication No. 2017-126978

PATENT LITERATURE 2: Japanese Laid-Open Patent Publication No. 2017-85663

### SUMMARY OF INVENTION

(1) A detection device according to the present disclosure is a detection device that detects an abnormality in an on-vehicle network including a plurality of on-vehicle devices, and includes: a monitoring unit configured to monitor transmission messages in the on-vehicle network, and acquire a communication load in the on-vehicle network; an acquisition unit configured to acquire a history of a communication load in an on-vehicle network to which the detection device belongs, or another on-vehicle network; and a detection unit configured to detect an abnormality in the on-vehicle network, based on the history acquired by the acquisition unit and on the communication load acquired by the monitoring unit at a first timing after the history.

(6) A detection device according to the present disclosure is a detection device that detects an abnormality in an on-vehicle network including a plurality of on-vehicle devices, and includes: a monitoring unit configured to monitor transmission messages in the on-vehicle network, and acquire a communication load in the on-vehicle network; an estimation unit configured to calculate, based on the communication load acquired in the past by the monitoring unit, an estimation value of the communication load to be acquired by the monitoring unit; an acquisition unit configured to acquire a history of a difference between an estimation value and a communication load in an on-vehicle network to which the detection device belongs, or another on-vehicle network; and a detection unit configured to detect an abnormality in the on-vehicle network, based on the history acquired by the acquisition unit, the communication load acquired by the monitoring unit at a first timing after the history, and the estimation value, of the communication load at the first timing, calculated by the estimation unit.

(7) A detection method according to the present disclosure is a detection method that is used by a detection device configured to detect an abnormality in an on-vehicle network including a plurality of on-vehicle devices, and includes: monitoring transmission messages in the on-vehicle network, and acquiring a communication load in the on-vehicle network; acquiring a history of a communication load in an on-vehicle network to which the detection device belongs, or another on-vehicle network; and detecting an abnormality in the on-vehicle network, based on the acquired history and on the communication load at a first timing after the history.

(8) A detection method according to the present disclosure is a detection method that is used by a detection device configured to detect an abnormality in an on-vehicle network including a plurality of on-vehicle devices, and includes: monitoring transmission messages in the on-vehicle network, and acquiring a communication load in the on-vehicle network; calculating an estimation value of the communication load, based on the communication load acquired in the past; acquiring a history of a difference between an estimation value and a communication load in an on-vehicle network to which the detection device belongs, or another on-vehicle network; and detecting an abnormality in the on-vehicle network, based on the acquired history, the communication load at a first timing after the history, and the estimation value of the communication load at the first timing.

(9) A detection program according to the present disclosure is a detection program that is used in a detection device configured to detect an abnormality in an on-vehicle network including a plurality of on-vehicle devices, and causes a computer to function as: a monitoring unit configured to monitor transmission messages in the on-vehicle network, and acquire a communication load in the on-vehicle network; an acquisition unit configured to acquire a history of a communication load in an on-vehicle network to which the detection device belongs, or another on-vehicle network; and a detection unit configured to detect an abnormality in the on-vehicle network, based on the history acquired by the acquisition unit and on the communication load acquired by the monitoring unit at a first timing after the history.

(10) A detection program according to the present disclosure is a detection program that is used in a detection device configured to detect an abnormality in an on-vehicle network including a plurality of on-vehicle devices, and causes a computer to function as: a monitoring unit configured to monitor transmission messages in the on-vehicle network, and acquire a communication load in the on-vehicle network; an estimation unit configured to calculate, based on the communication load acquired in the past by the monitoring unit, an estimation value of the communication load to be acquired by the monitoring unit; an acquisition unit configured to acquire a history of a difference between an estimation value and a communication load in an on-vehicle network to which the detection device belongs, or another on-vehicle network; and a detection unit configured to detect an abnormality in the on-vehicle network, based on the history acquired by the acquisition unit, the communication load acquired by the monitoring unit at a first timing after the history, and the estimation value, of the communication load at the first timing, calculated by the estimation unit.

One mode of the present disclosure can be realized as a detection device that includes such a characteristic processing unit, and can also be realized as an on-vehicle communication system including the detection device. In addition, one mode of the present disclosure can also be realized as a semiconductor integrated circuit that realizes a part of or the entire detection device.

One mode of the present disclosure can be realized as a gateway device that includes such a characteristic processing unit, and can also be realized as an on-vehicle communication system including the gateway device. In addition, one mode of the present disclosure can also be realized as a semiconductor integrated circuit that realizes a part of or the entire gateway device.

### BRIEF DESCRIPTION OF DRAWINGS

FIG. 1 shows a configuration of an on-vehicle communication system according to a first embodiment of the present disclosure.

FIG. 2 shows a configuration of a bus connection device group according to the first embodiment of the present disclosure.

FIG. 3 shows a configuration of a gateway device in the on-vehicle communication system according to the first embodiment of the present disclosure.

FIG. 4 shows an example of a frequency distribution of a communication load in the on-vehicle communication system according to the first embodiment of the present disclosure.

FIG. 5 shows an example of detection of a traffic abnormality by a detection unit in the gateway device according to the first embodiment of the present disclosure.

FIG. 6 is a flowchart of an operation procedure when the gateway device according to the first embodiment of the present disclosure performs detection of a traffic abnormality in a detection target bus.

FIG. 7 shows an example of a connection topology of an on-vehicle network according to the first embodiment of the present disclosure.

FIG. 8 shows a configuration of a gateway device according to a second embodiment of the present disclosure.

FIG. 9 is a flowchart of an operation procedure when the gateway device according to the second embodiment of the present disclosure performs detection of a traffic abnormality in a detection target bus.

FIG. 10 shows an example of temporal change in communication load in an on-vehicle communication system according to the second embodiment of the present disclosure.

FIG. 11 shows a configuration of a gateway device according to a third embodiment of the present disclosure.

FIG. 12 shows an example of temporal change in communication load in an on-vehicle communication system according to the third embodiment of the present disclosure.

FIG. 13 shows an example of a frequency distribution of error of communication load in the on-vehicle communication system according to the third embodiment of the present disclosure.

FIG. 14 shows an example of estimation of occurrence of an unauthorized message by a detection unit in the gateway device according to the third embodiment of the present disclosure.

FIG. 15 is a flowchart of an operation procedure when the gateway device according to the third embodiment of the present disclosure performs detection of a traffic abnormality and estimation of occurrence of an unauthorized message in a detection target bus.

FIG. 16 is a flowchart of an operation procedure when a gateway device according to a modification of the third embodiment of the present disclosure performs estimation of occurrence of an unauthorized message in a detection target bus.

FIG. 17 shows an example of temporal change in communication load in the on-vehicle communication system according to the third embodiment of the present disclosure.

### DESCRIPTION OF EMBODIMENTS

To date, on-vehicle network systems for improving security in on-vehicle networks have been developed.

### Problems to be Solved by the Present Disclosure

In the abnormality detection device described in PATENT LITERATURE 1, the specification unit generates feature information that is a feature vector having, as a component, the number of frames per message ID received, performs an arithmetic process using the feature information and the predetermined model, and determines whether or not the feature information deviates from the reference represented by the predetermined model, based on the result of the arithmetic process, thereby detecting an abnormality.

In the abnormality detection device described in PATENT LITERATURE 1, however, in order to determine whether or not the feature vector deviates from the reference, a complicated process, such as calculating a nearest neighbor distance, of the feature vector, with respect to a reference indicated by a predetermined model represented by a data structure such as a kd-tree and comparing the nearest neighbor distance with a threshold value, is required. Such a complicated process causes a large load on a CPU (Central Processing Unit) or the like.

Meanwhile, in the security device described in PATENT LITERATURE 2, in order to determine whether or not the reception interval between the two frames having the same ID is outside the predetermined allowable range, transmission times of the respective frames need to be acquired. Such a process causes a large load on a CPU or the like.

The present disclosure is made to solve the above problems. An object of the present disclosure is to provide a detection device, a gateway device, a detection method, and a detection program that can accurately detect an abnormality in an on-vehicle network through a simple process.

### Effects of the Present Disclosure

According to the present disclosure, it is possible to accurately detect an abnormality in an on-vehicle network through a simple process.

### Description of Embodiment of the Present Disclosure

First, contents of embodiments of the present disclosure are listed and described.

(1) A detection device according to an embodiment of the present disclosure is a detection device that detects an abnormality in an on-vehicle network including a plurality of on-vehicle devices, and includes: a monitoring unit configured to monitor transmission messages in the on-vehicle network, and acquire a communication load in the on-vehicle network; an acquisition unit configured to acquire a history of a communication load in an on-vehicle network to which the detection device belongs, or another on-vehicle network; and a detection unit configured to detect an abnormality in the on-vehicle network, based on the history acquired by the acquisition unit and on the communication load acquired by the monitoring unit at a first timing after the history.

For example, if an abnormality occurs in the on-vehicle network, the communication load at the first timing acquired by the monitoring unit has a great value. In the above configuration, focus is placed on the communication load, and an abnormality in the on-vehicle network is detected based on the history of the communication load and the communication load at the first timing. Thus, an abnormality in the on-vehicle network can be accurately detected through a simple process.

(2) Preferably, the detection device further includes an estimation unit configured to calculate an estimation value of the communication load at the first timing, based on the communication load acquired by the monitoring unit at a timing before the first timing. The detection unit compares the communication load acquired at the first timing by the monitoring unit with the estimation value at the first timing calculated by the estimation unit, and estimates occurrence of an unauthorized message in the on-vehicle network, based on a result of the comparison.

In the above configuration, even in a situation where an abnormality in the on-vehicle network is not detected from the communication load at the first timing, occurrence of an unauthorized message in the on-vehicle network can be estimated based on the result of the comparison between the communication load and the estimation value estimated from the communication load at the timing before the first timing. Thus, occurrence of an unauthorized message in the on-vehicle network can be estimated earlier than the timing at which an abnormality in the on-vehicle network can be detected based on the communication load.

(3) More preferably, when occurrence of an unauthorized message has been estimated by the detection unit, the estimation unit calculates the estimation value at a second timing after the first timing, based on the communication load acquired at a timing on or after the first timing.

In this configuration, a new estimation value can be calculated more accurately based on the communication load acquired at the timing when the communication load was significantly increased or subsequent timing. Therefore, for example, even when the communication load is further changed, occurrence of an unauthorized message in the on-vehicle network can be accurately estimated based on the newly calculated estimation value.

(4) More preferably, the detection device further includes a notification unit configured to output first alarm information when an abnormality in the on-vehicle network has been detected by the detection unit, and output second alarm information different from the first alarm information when occurrence of an unauthorized message in the on-vehicle network has been estimated by the detection unit.

In the above configuration, the notification unit transmits the different types of alarm information between the case where an abnormality in the on-vehicle network has been detected and the case where occurrence of an unauthorized message in the on-vehicle network has been estimated. Therefore, for example, it is possible to notify a user of alarms having different degrees of emergency according to the situation.

(5) More preferably, the monitoring unit calculates, as the communication load at the first timing, a moving average of time series data of the communication load.

In the above configuration, the moving average having less variation than the communication load can be used for detection of an abnormality in the on-vehicle network. Thus, an abnormality in the on-vehicle network can be detected more accurately and stably.

(6) A detection device according to an embodiment of the present disclosure is a detection device that detects an abnormality in an on-vehicle network including a plurality of on-vehicle devices, and includes: a monitoring unit configured to monitor transmission messages in the on-vehicle network, and acquire a communication load in the on-vehicle network; an estimation unit configured to calculate, based on the communication load acquired in the past by the monitoring unit, an estimation value of the communication load to be acquired by the monitoring unit; an acquisition unit configured to acquire a history of a difference between an estimation value and a communication load in an on-vehicle network to which the detection device belongs, or another on-vehicle network; and a detection unit configured to detect an abnormality in the on-vehicle network, based on the history acquired by the acquisition unit, the communication load acquired by the monitoring unit at a first timing after the history, and the estimation value, of the communication load at the first timing, calculated by the estimation unit.

For example, if an abnormality occurs in the on-vehicle network, the difference between the communication load at the first timing acquired by the monitoring unit and the estimation value, of the communication load at the first timing, calculated by the estimation unit has a great value. In the above configuration, focus is placed on the difference between the communication load and the estimation value, and an abnormality in the on-vehicle network is detected based on the history of the difference between the communication load and the estimation value, the communication load at the first timing, and the estimation value of the communication load at the first timing. Thus, an abnormality in the on-vehicle network can be accurately detected through a simple process.

A gateway device according to an embodiment of the present disclosure is a gateway device that relays messages between on-vehicle devices in an on-vehicle network, and includes: a monitoring unit configured to monitor transmission messages in the on-vehicle network, and acquire a communication load in the on-vehicle network; an acquisition unit configured to acquire a history of a communication load in an on-vehicle network to which the detection device belongs, or another on-vehicle network; and a detection unit configured to detect an abnormality in the on-vehicle network, based on the history acquired by the acquisition unit and on the communication load acquired by the monitoring unit at a first timing after the history.

For example, if an abnormality occurs in the on-vehicle network, the communication load at the first timing acquired by the monitoring unit has a great value. In the above configuration, focus is placed on the communication load, and an abnormality in the on-vehicle network is detected based on the history of the communication load and the communication load at the first timing. Thus, an abnormality in the on-vehicle network can be accurately detected through a simple process.

A gateway device according to an embodiment of the present disclosure is a gateway device that relays messages between on-vehicle devices in an on-vehicle network, and includes: a monitoring unit configured to monitor transmission messages in the on-vehicle network, and acquire a communication load in the on-vehicle network; an estimation unit configured to calculate, based on the communication load acquired in the past by the monitoring unit, an estimation value of the communication load to be acquired by the monitoring unit; an acquisition unit configured to acquire a history of a difference between an estimation value and a communication load in an on-vehicle network to which the detection device belongs, or another on-vehicle network; and a detection unit configured to detect an abnormality in the on-vehicle network, based on the history acquired by the acquisition unit, the communication load acquired by the monitoring unit at a first timing after the history, and the estimation value, of the communication load at the first timing, calculated by the estimation unit.

For example, if an abnormality occurs in the on-vehicle network, the difference between the communication load at the first timing acquired by the monitoring unit and the estimation value, of the communication load at the first timing, calculated by the estimation unit has a great value. In the above configuration, focus is placed on the difference between the communication load and the estimation value, and an abnormality in the on-vehicle network is detected based on the history of the difference between the communication load and the estimation value, the communication load at the first timing, and the estimation value of the communication load at the first timing. Thus, an abnormality in the on-vehicle network can be accurately detected through a simple process.

(7) A detection method according to an embodiment of the present disclosure is a detection method that is used by a detection device configured to detect an abnormality in an on-vehicle network including a plurality of on-vehicle devices, and includes: monitoring transmission messages in the on-vehicle network, and acquiring a communication load in the on-vehicle network; acquiring a history of a communication load in an on-vehicle network to which the detection device belongs, or another on-vehicle network; and detecting an abnormality in the on-vehicle network, based on the acquired history and on the communication load at a first timing after the history.

For example, if an abnormality occurs in the on-vehicle network, the communication load at the first timing acquired by the monitoring unit has a great value. In the above method, focus is placed on the communication load, and an abnormality in the on-vehicle network is detected based on the history of the communication load and the communication load at the first timing. Thus, an abnormality in the on-vehicle network can be accurately detected through a simple process.

(8) A detection method according to an embodiment of the present disclosure is a detection method that is used by a detection device configured to detect an abnormality in an on-vehicle network including a plurality of on-vehicle devices, and includes: monitoring transmission messages in the on-vehicle network, and acquiring a communication load in the on-vehicle network; calculating an estimation value of the communication load, based on the communication load acquired in the past; acquiring a history of a difference between an estimation value and a communication load in an on-vehicle network to which the detection device belongs, or another on-vehicle network; and detecting an abnormality in the on-vehicle network, based on the acquired history, the communication load at a first timing after the history, and the estimation value of the communication load at the first timing.

For example, if an abnormality occurs in the on-vehicle network, the difference between the communication load at the first timing and the estimation value has a great value. In the above method, focus is placed on the difference between the communication load and the estimation value, and an abnormality in the on-vehicle network is detected based on the history of the difference between the communication load and the estimation value, the communication load at the first timing, and the estimation value of the communication load at the first timing. Thus, an abnormality in the on-vehicle network can be accurately detected through a simple process.

A detection method according to an embodiment of the present disclosure is a detection method that is used by a gateway device configured to relay messages between on-vehicle devices in an on-vehicle network, and includes: monitoring transmission messages in the on-vehicle network, and acquiring a communication load in the on-vehicle network; acquiring a history of a communication load in an on-vehicle network to which the detection device belongs, or another on-vehicle network; and detecting an abnormality in the on-vehicle network, based on the acquired history and on the communication load at a first timing after the history.

For example, if an abnormality occurs in the on-vehicle network, the communication load at the first timing acquired by the monitoring unit has a great value. In the above method, focus is placed on the communication load, and an abnormality in the on-vehicle network is detected based on the history of the communication load and the communication load at the first timing. Thus, an abnormality in the on-vehicle network can be accurately detected through a simple process.

A detection method according to an embodiment of the present disclosure is a detection method that is used by a gateway device configured to relay messages between on-vehicle devices in an on-vehicle network, and includes: monitoring transmission messages in the on-vehicle network, and acquiring a communication load in the on-vehicle network; calculating, based on the communication load acquired in the past, an estimation value of the communication load; acquiring a history of a difference between an estimation value and a communication load in an on-vehicle network to which the detection device belongs, or another on-vehicle network; and detecting an abnormality in the on-vehicle network, based on the acquired history, the communication load at a first timing after the history, and the estimation value of the communication load at the first timing.

For example, if an abnormality occurs in the on-vehicle network, the difference between the communication load at the first timing and the estimation value has a great value. In the above method, focus is placed on the difference between the communication load and the estimation value, and an abnormality in the on-vehicle network is detected based on the history of the difference between the communication load and the estimation value, the communication load at the first timing, and the estimation value of the communication load at the first timing. Thus, an abnormality in the on-vehicle network can be accurately detected through a simple process.

(9) A detection program according to an embodiment of the present disclosure is a detection program that is used in a detection device configured to detect an abnormality in an on-vehicle network including a plurality of on-vehicle devices, and causes a computer to function as: a monitoring unit configured to monitor transmission messages in the on-vehicle network, and acquire a communication load in the on-vehicle network; an acquisition unit configured to acquire a history of a communication load in an on-vehicle network to which the detection device belongs, or another on-vehicle network; and a detection unit configured to detect an abnormality in the on-vehicle network, based on the history acquired by the acquisition unit and on the communication load acquired by the monitoring unit at a first timing after the history.

For example, if an abnormality occurs in the on-vehicle network, the communication load at the first timing acquired by the monitoring unit has a great value. In the above configuration, focus is placed on the communication load, and an abnormality in the on-vehicle network is detected based on the history of the communication load and the communication load at the first timing. Thus, an abnormality in the on-vehicle network can be accurately detected through a simple process.

(10) A detection program according to an embodiment of the present disclosure is a detection program that is used in a detection device configured to detect an abnormality in an on-vehicle network including a plurality of on-vehicle devices, and causes a computer to function as: a monitoring unit configured to monitor transmission messages in the on-vehicle network, and acquire a communication load in the on-vehicle network; an estimation unit configured to calculate, based on the communication load acquired in the past by the monitoring unit, an estimation value of the communication load to be acquired by the monitoring unit; an acquisition unit configured to acquire a history of a difference between an estimation value and a communication load in an on-vehicle network to which the detection device belongs, or another on-vehicle network; and a detection unit configured to detect an abnormality in the on-vehicle network, based on the history acquired by the acquisition unit, the communication load acquired by the monitoring unit at a first timing after the history, and the estimation value, of the communication load at the first timing, calculated by the estimation unit.

For example, if an abnormality occurs in the on-vehicle network, the difference between the communication load at the first timing acquired by the monitoring unit and the estimation value, of the communication load at the first timing, calculated by the estimation unit has a great value. In the above configuration, focus is placed on the difference between the communication load and the estimation value, and an abnormality in the on-vehicle network is detected based on the history of the difference between the communication load and the estimation value, the communication load at the first timing, and the estimation value of the communication load at the first timing. Thus, an abnormality in the on-vehicle network can be accurately detected through a simple process.

A detection program according to an embodiment of the present disclosure is a detection program that is used in a gateway device configured to relay messages between on-vehicle devices in an on-vehicle network, and causes a computer to function as: a monitoring unit configured to monitor transmission messages in the on-vehicle network, and acquire a communication load in the on-vehicle network; an acquisition unit configured to acquire a history of a communication load in an on-vehicle network to which the detection device belongs, or another on-vehicle network; and a detection unit configured to detect an abnormality in the on-vehicle network, based on the history acquired by the acquisition unit and on the communication load acquired by the monitoring unit at a first timing after the history.

For example, if an abnormality occurs in the on-vehicle network, the communication load at the first timing acquired by the monitoring unit has a great value. In the above configuration, focus is placed on the communication load, and an abnormality in the on-vehicle network is detected based on the history of the communication load and the communication load at the first timing. Thus, an abnormality in the on-vehicle network can be accurately detected through a simple process.

A detection program according to an embodiment of the present disclosure is a detection program that is used in a gateway device configured to relay messages between on-vehicle devices in an on-vehicle network, and causes a computer to function as: a monitoring unit configured to monitor transmission messages in the on-vehicle network, and acquire a communication load in the on-vehicle network; an estimation unit configured to calculate, based on the communication load acquired in the past by the monitoring unit, an estimation value of the communication load to be acquired by the monitoring unit; an acquisition unit configured to acquire a history of a difference between an estimation value and a communication load in an on-vehicle network to which the detection device belongs, or another on-vehicle network; and a detection unit configured to detect an abnormality in the on-vehicle network, based on the history acquired by the acquisition unit, the communication load acquired by the monitoring unit at a first timing after the history, and the estimation value, of the communication load at the first timing, calculated by the estimation unit.

For example, if an abnormality occurs in the on-vehicle network, the difference between the communication load at the first timing acquired by the monitoring unit and the estimation value, of the communication load at the first timing, calculated by the estimation unit has a great value. In the above configuration, focus is placed on the difference between the communication load and the estimation value, and an abnormality in the on-vehicle network is detected based on the history of the difference between the communication load and the estimation value, the communication load at the first timing, and the estimation value of the communication load at the first timing. Thus, an abnormality in the on-vehicle network can be accurately detected through a simple process.

Hereinafter, embodiments of the present disclosure will be described with reference to the drawings. In the drawings, the same or corresponding parts are denoted by the same reference signs, and descriptions thereof are not repeated. At least some parts of the embodiments described below can be combined together as desired.

### First Embodiment

[Configuration and Basic Operation]

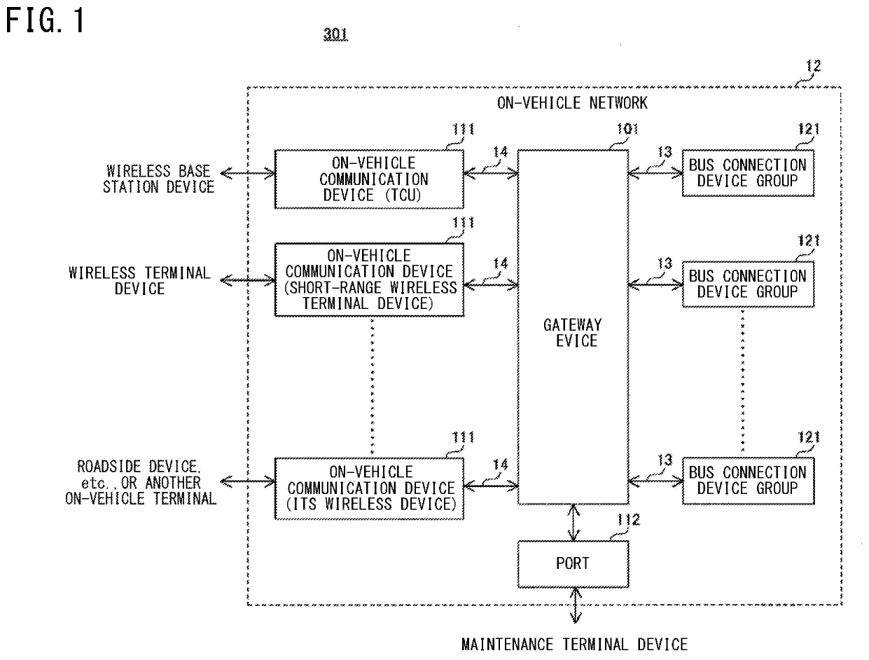

FIG. 1 shows a configuration of an on-vehicle communication system according to a first embodiment of the present disclosure.

With reference to FIG. 1, an on-vehicle communication system 301 includes a gateway device (detection device) 101, a plurality of on-vehicle communication devices 111, and a plurality of bus connection device groups 121.

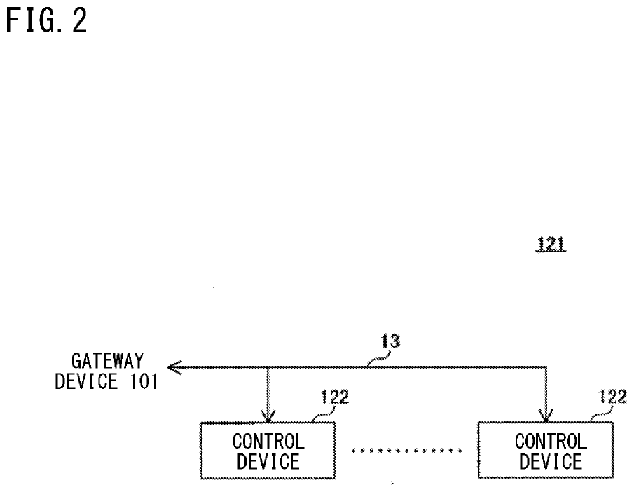

FIG. 2 shows a configuration of a bus connection device group according to the first embodiment of the present disclosure.

With reference to FIG. 2, the bus connection device group 121 includes a plurality of control devices 122. The bus connection device group 121 need not necessarily include a plurality of control devices 122, and may include one control device 122.

The on-vehicle communication system 301 is mounted in a vehicle (hereinafter, also referred to as a target vehicle) which travels on a road. An on-vehicle network 12 includes a plurality of on-vehicle devices which are devices provided in the vehicle. Specifically, the on-vehicle network 12 includes a plurality of on-vehicle communication devices 111 and a plurality of control devices 122, which are examples of the on-vehicle devices. As long as the on-vehicle network 12 includes a plurality of on-vehicle devices, the on-vehicle network 12 may be configured to include a plurality of on-vehicle communication devices 111 and not to include any control device 122, may be configured not to include any on-vehicle communication device 111 and to include a plurality of control devices 122, or may be configured to include one on-vehicle communication device 111 and one control device 122.

In the on-vehicle network 12, the on-vehicle communication device 111 communicates with a device outside the target vehicle, for example. Specifically, the on-vehicle communication device 111 is a TCU (Telematics Communication Unit), a short-range wireless terminal device, or an ITS (Intelligent Transport Systems) wireless device, for example.

The TCU can perform wireless communication with a wireless base station device in accordance with a communication standard such as LTE (Long Term Evolution) or 3G, and can perform communication with the gateway device 101, for example. The TCU relays information to be used in services such as navigation, vehicle burglar prevention, remote maintenance, and FOTA (Firmware Over The Air), for example.

For example, the short-range wireless terminal device can perform wireless communication with a wireless terminal device such as a smartphone held by a person (hereinafter, also referred to as an occupant) in the target vehicle, in accordance with a communication standard such as Wi-Fi (registered trademark) and Bluetooth (registered trademark), and can perform communication with the gateway device 101. The short-range wireless terminal device relays information to be used in a service such as entertainment, for example.

For example, the short-range wireless terminal device can perform wireless communication with a wireless terminal device such as a smart key held by the occupant and with a wireless terminal device provided at a tire, in accordance with a predetermined communication standard by using a radio wave in an LF (Low Frequency) band or a UHF (Ultra High Frequency) band, and can perform communication with the gateway device 101. The short-range wireless terminal device relays information to be used in services such as smart entry and TPMS (Tire Pressure Monitoring System), for example.

The ITS wireless device can perform roadside-to-vehicle communication with a roadside device, such as an optical beacon, a radio wave beacon, or an ITS spot, provided in the vicinity of a road, can perform vehicle-to-vehicle communication with an on-vehicle terminal mounted in another vehicle, and can perform communication with the gateway device 101, for example. The ITS wireless device relays information to be used in services such as congestion alleviation, safe driving support, and route guidance, for example.

The gateway device 101 can, via a port 112, transmit/receive data for update or the like of firmware, and data, etc., accumulated by the gateway device 101 to/from a maintenance terminal device outside the target vehicle, for example.

The gateway device 101 is connected to on-vehicle devices via buses 13, 14, for example. Specifically, each bus 13, 14 is a bus according to, for example, a standard of CAN (Controller Area Network) (registered trademark), FlexRay (registered trademark), MOST (Media Oriented Systems Transport) (registered trademark), Ethernet (registered trademark), LIN (Local Interconnect Network), or the like.

In this example, each on-vehicle communication device 111 is connected to the gateway device 101 via a corresponding bus 14 according to the Ethernet standard. Each control device 122 in each bus connection device group 121 is connected to the gateway device 101 via a corresponding bus 13 according to the CAN standard. The control device 122 can control a function unit in the target vehicle, for example.

The buses 13 are provided for respective types of systems, for example. Specifically, the buses 13 are implemented as a drive-related bus, a chassis/safety-related bus, a body/electrical-equipment-related bus, and an AV/information-related bus, for example.

The drive-related bus has connected thereto an engine control device, an AT (Automatic Transmission) control device, and an HEV (Hybrid Electric Vehicle) control device, which are examples of the control device 122. The engine control device, the AT control device, and the HEV control device control an engine, AT, and switching between the engine and a motor, respectively.

The chassis/safety-related bus has connected thereto a brake control device, a chassis control device, and a steering control device, which are examples of the control device 122. The brake control device, the chassis control device, and the steering control device control a brake, a chassis, and steering, respectively.

The body/electrical-equipment-related bus has connected thereto an instrument indication control device, an air conditioner control device, a burglar prevention control device, an air bag control device, and a smart entry control device, which are examples of the control device 122. The instrument indication control device, the air conditioner control device, the burglar prevention control device, the air bag control device, and the smart entry control device control instruments, an air conditioner, a burglar prevention mechanism, an air bag mechanism, and smart entry, respectively.

The AV/information-related bus has connected thereto a navigation control device, an audio control device, an ETC (Electronic Toll Collection System) (registered trademark) control device, and a telephone control device, which are examples of the control device 122. The navigation control device, the audio control device, the ETC control device, and the telephone control device control a navigation device, an audio device, an ETC device, and a mobile phone, respectively.

The bus 13 need not necessarily have the control devices 122 connected thereto, and may have connected thereto a device other than the control devices 122.

The gateway device 101 is a central gateway (CGW), for example, and can perform communication with the on-vehicle devices.

The gateway device 101 performs a relay process of relaying information transmitted/received between control devices 122 that are connected to different buses 13 in the target vehicle, information transmitted/received between on-vehicle communication devices 111, and information transmitted/received between a control device 122 and an on-vehicle communication device 111, for example.

More specifically, in the on-vehicle network 12, a message is periodically or non-periodically transmitted from an on-vehicle device to another on-vehicle device. Transmission of the message may be performed by broadcast or may be performed by unicast.

In the following, a message that is transmitted from a control device 122 to another control device 122 is described. However, the same also applies to a message that is transmitted between a control device 122 and an on-vehicle communication device 111, and a message that is transmitted between on-vehicle communication devices 111.

[Configuration of Gateway Device]

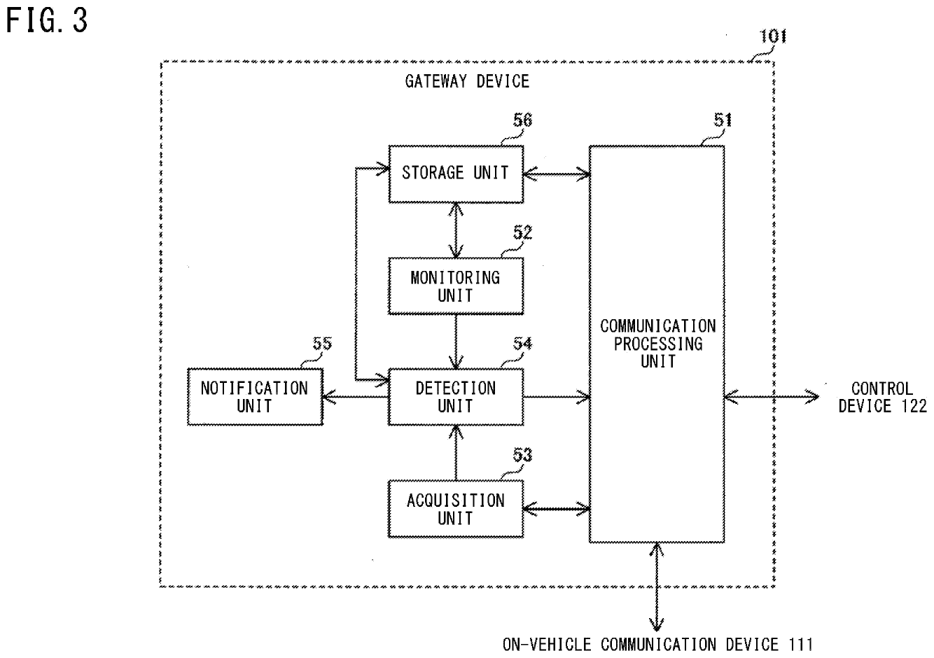

FIG. 3 shows the configuration of the gateway device in the on-vehicle communication system according to the first embodiment of the present disclosure.

With reference to FIG. 3, the gateway device 101 includes a communication processing unit 51, a monitoring unit 52, an acquisition unit 53, a detection unit 54, a notification unit 55, and a storage unit 56. The storage unit 56 is a nonvolatile memory, for example.

The gateway device 101 functions as a detection device, and performs a detection process of detecting an abnormality in the on-vehicle network 12.

More specifically, as the process of detecting an abnormality in the on-vehicle network 12, the gateway device 101 detects an abnormality of communication traffic (hereinafter, also referred to as “traffic abnormality”) due to an unauthorized message, in a bus to be subjected to abnormality detection (hereinafter, also referred to as “detection target bus”) among the buses 13.

[Communication Processing Unit]

The communication processing unit 51 performs a relay process. More specifically, upon receiving a message from a control device 122 via a corresponding bus 13, the communication processing unit 51 stores the received message in the storage unit 56. Then, the communication processing unit 51 acquires the message from the storage unit 56, and transmits the acquired message to a control device 122 as a destination via a corresponding bus 13.

More specifically, for example, the storage unit 56 is provided with a plurality of queues corresponding to the respective bus connection device groups 121 which are destinations of messages. In other words, the storage unit 56 is provided with a plurality of queues corresponding to the respective buses 13 through which messages are transmitted.

For example, upon receiving a message, the communication processing unit 51 distributes the message to any of the queues corresponding to the bus connection device groups 121 as destinations, to store the message in the queue. Then, the communication processing unit 51 acquires the message from the queue in the storage unit 56, and transmits the acquired message to a bus connection device group 121 as a destination via a corresponding bus 13.

[Monitoring Unit]

The monitoring unit 52 monitors transmission messages in the on-vehicle network 12, and acquires a communication load in the on-vehicle network 12. For example, the monitoring unit 52 monitors messages in the storage unit 56 to acquire a communication load of a detection target bus.

For example, the storage unit 56 stores therein an upper-limit value of a data amount (hereinafter, also referred to as “maximum communication traffic”) that can be transmitted per unit time period in each bus 13. The monitoring unit 52 acquires the maximum communication traffic of the detection target bus from the storage unit 56.

The monitoring unit 52 monitors messages in a queue corresponding to the detection target bus among the queues in the storage unit 56, and acquires the total amount of data of messages transmitted per unit time period via the detection target bus.

The monitoring unit 52 divides the acquired total amount of data by the maximum communication traffic of the detection target bus, thereby calculating a communication load L of the detection target bus.

In one example, the monitoring unit 52 acquires the number of messages stored in the corresponding queue in the storage unit 56, and calculates the total amount of data of messages transmitted per unit time period via the detection target bus, based on the acquired number of messages.

In another example, the monitoring unit 52 refers to a DLC (Data Length Code) included in each of the messages stored in the corresponding queue in the storage unit 56 to acquire the amount of data in the data field of the message, and calculates the total amount of data of messages transmitted per unit time period via the detection target bus, based on the total sum of acquired data amounts. A DLC is composed of 4 bits, and indicates the length of the data field.

For example, the storage unit 56 stores therein setting information indicating an acquisition cycle Cl of the communication load L, and the like. The monitoring unit 52 acquires the setting information from the storage unit 56. According to the acquired setting information, the monitoring unit 52 acquires the communication load L of the detection target bus at an acquisition timing based on the acquisition cycle Cl, and outputs the acquired communication load L to the detection unit 54.

[Acquisition Unit]

The acquisition unit 53 acquires the history of a communication load L in an on-vehicle network to which the acquisition unit 53 belongs, or another on-vehicle network. For example, the acquisition unit 53 acquires the history of the communication load L, of the detection target bus, acquired by the monitoring unit 52.

The acquisition unit 53 acquires, for example, as the history of the communication load L of the detection target bus, distribution information F1 which has been created in advance by another device such as a server and indicates a frequency distribution of the communication load L of the detection target bus.

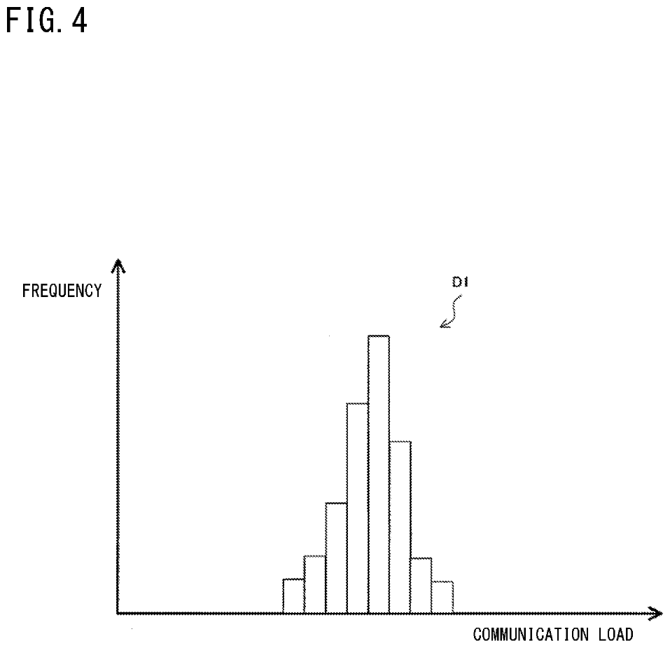

FIG. 4 shows an example of the frequency distribution of the communication load in the on-vehicle communication system according to the first embodiment of the present disclosure. In FIG. 4, the vertical axis represents frequency and the horizontal axis represents communication load L.

With reference to FIG. 4, the server creates, for each bus 13, a frequency distribution D1 of the communication load L, based on the communication load L, for each bus 13, acquired over a certain time period by the monitoring unit 52. This communication load L is acquired in a test vehicle of the same type as the target vehicle, that is, in another on-vehicle network, for example. The server may create the frequency distribution D1 based on the communication load L acquired in the target vehicle, that is, in the on-vehicle network of the target vehicle.

Based on the created frequency distribution D1, the server calculates a sample average, a sample standard deviation, etc., of the communication load L. Upon receiving a transmission request for the distribution information F1 from the acquisition unit 53, the server transmits, to the target vehicle as a request source, the distribution information F1 including the sample average, the sample standard deviation, etc., of the communication load L.

Referring back to FIG. 3, the acquisition unit 53 transmits, to the server, the transmission request for the distribution information F1 of the detection target bus, thereby acquiring the distribution information F1. The acquisition unit 53 receives the distribution information F1 from the server via the on-vehicle communication device 111 and the communication processing unit 51, and outputs the received distribution information F1 to the detection unit 54.

In the gateway device 101, the acquisition unit 53 receives the distribution information F1 from the server via the on-vehicle communication device 111 and the communication processing unit 51. However, the present disclosure is not limited thereto. For example, the server or a maintenance terminal device may store the distribution information F1 of each bus 13 into the storage unit 56, and the acquisition unit 53 may acquire the distribution information F1 of the detection target bus from the storage unit 56.

[Detection Unit]

The detection unit 54 detects an abnormality in the on-vehicle network 12, based on the history of the communication load L acquired by the acquisition unit 53 and on the communication load L acquired by the monitoring unit 52 at a first timing after the history. More specifically, the detection unit 54 detects a traffic abnormality in the detection target bus, based on the history and the communication load L that is acquired at an acquisition timing t after the acquisition timing of each communication load L included in the history. In the description below, the communication load L acquired by the monitoring unit 52 at the acquisition timing t is referred to as “communication load Lt”.

For example, the detection unit 54 detects a traffic abnormality in the detection target bus, based on the distribution information F1 received from the acquisition unit 53 and on the communication load Lt received from the monitoring unit 52.

More specifically, it can be assumed that the frequency distribution D1 created by the server is the frequency distribution of the communication load L obtained when no traffic abnormality occurs in the detection target bus. The detection unit 54 detects a traffic abnormality in the detection target bus, based on the distribution information F1 corresponding to the frequency distribution D1 and on the communication load Lt received from the monitoring unit 52.

For example, based on the distribution information F1 received from the acquisition unit 53, the detection unit 54 creates, as a model, a probability density function by approximating the frequency distribution D1 of the communication load L with a normal distribution, and detects a traffic abnormality in the detection target bus, based on the created model and the communication load Lt received from the monitoring unit 52.

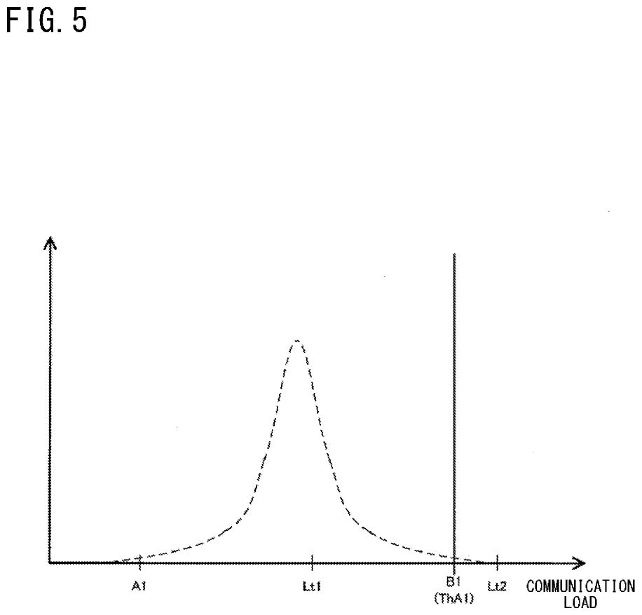

FIG. 5 shows an example of detection of a traffic abnormality by the detection unit in the gateway device according to the first embodiment of the present disclosure. In FIG. 5, the horizontal axis represents communication load. In FIG. 5, a broken line indicates a probability density function obtained by approximating the frequency distribution D1 of the communication load L with a normal distribution.

With reference to FIG. 3 and FIG. 5, upon receiving the distribution information F1 from the acquisition unit 53, the detection unit 54 calculates, based on the distribution information F1, a lower-limit value A1 and an upper-limit value B1 of a reliable section of an average value of the communication load L in the case where the communication traffic is normal, and sets the calculated upper-limit value B1 as a threshold value ThA1.

Upon receiving the communication load Lt from the monitoring unit 52, the detection unit 54 compares the received communication load Lt with the threshold value ThA1.

For example, when the communication load Lt1 acquired by the monitoring unit 52 at the acquisition timing t1 is equal to or smaller than the threshold value ThA1, the detection unit 54 determines that no traffic abnormality occurs in the detection target bus.

The reason is as follows. That is, for example, when no traffic abnormality occurs in the detection target bus at the acquisition timing t1, the communication load Lt is highly likely to be positioned near the center of the probability density function shown in FIG. 5 and therefore is less likely to exceed the threshold value ThA1.

On the other hand, when a communication load Lt2 acquired by the monitoring unit 52 at an acquisition timing t2 is greater than the threshold value ThA1, the detection unit 54 determines that a traffic abnormality occurs in the detection target bus.

The reason is as follows. That is, for example, when a traffic abnormality occurs in the detection target bus at the acquisition timing t2, the communication load Lt2 has a great value and therefore is highly likely to exceed the threshold value ThA1.

The detection unit 54 outputs determination information indicating a determination result based on the communication load Lt and the threshold value ThA1 to the communication processing unit 51 and the notification unit 55.

When the determination information received from the detection unit 54 indicates that no traffic abnormality occurs in the detection target bus, the communication processing unit 51 normally performs the relay process via the detection target bus. Specifically, the communication processing unit 51 transmits a message to the control device 122 as a destination via the detection target bus.

On the other hand, when the determination information received from the detection unit 54 indicates that a traffic abnormality occurs in the detection target bus, the communication processing unit 51 stops the relay process via the detection target bus, for example. Then, the communication processing unit 51 records, as a log, the message and the detection target bus indicated by the determination information into the storage unit 56.

When the determination information received from the detection unit 54 indicates that a traffic abnormality occurs in the detection target bus, the notification unit 55 transmits alarm information indicating the occurrence of the traffic abnormality in the detection target bus, to the on-vehicle devices in the target vehicle or a higher-order device outside the target vehicle.

[Operation]

Each device in the on-vehicle communication system 301 includes a computer including a memory. An arithmetic processing unit such as a CPU in the computer reads out, from the memory, a program including a part or all of steps in the flowchart below, and executes the program. The programs for the plurality of devices can be installed from the outside. The programs for the plurality of devices are each distributed in a state of being stored in a storage medium.

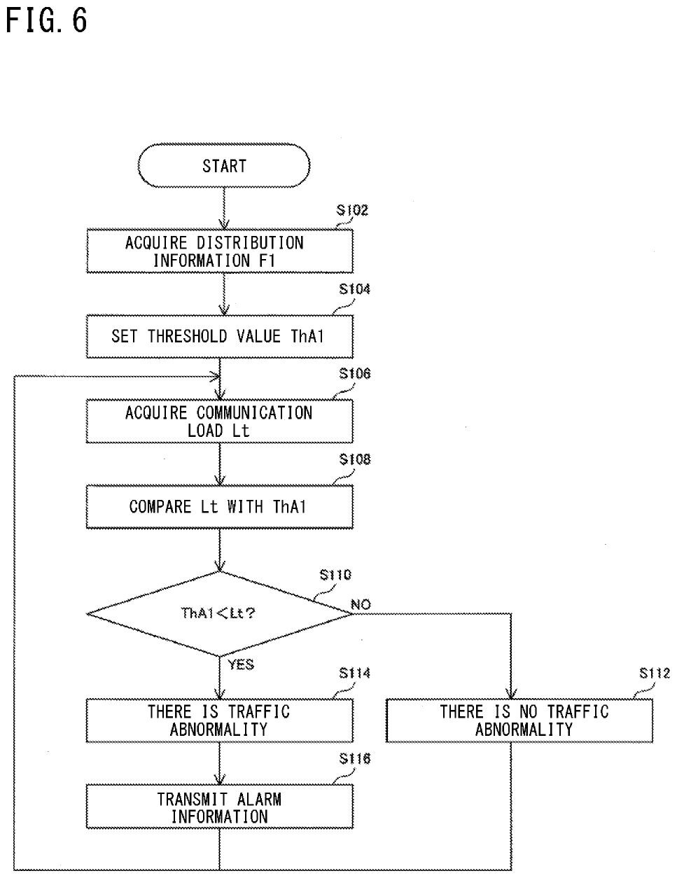

FIG. 6 is a flowchart of an operation procedure when the gateway device according to the first embodiment of the present disclosure performs detection of a traffic abnormality in a detection target bus.

With reference to FIG. 6, firstly, the gateway device 101 acquires distribution information F1 indicating a frequency distribution D1 of a communication load L of the detection target bus (step S102).

Next, the gateway device 101 sets a threshold value ThA1, based on the distribution information F1 (step S104).

Next, the gateway device 101 acquires a communication load Lt of the detection target bus at an acquisition timing t (step S106).

Next, the gateway device 101 compares the communication load Lt with the set threshold value ThA1 (step S108).

When the communication load Lt is equal to or smaller than the threshold value ThA1 (NO in step S110), the gateway device 101 determines that no traffic abnormality occurs in the detection target bus and therefore the communication traffic is normal (step S112).

Next, the gateway device 101 performs a process of acquiring a communication load Lt+1 of the detection target bus at the next acquisition timing t+1 (step S106), a process of comparing the communication load Lt+1 with the threshold value ThA1 (step S108), and the like.

On the other hand, when the communication load Lt is greater than the threshold value ThA1 (YES in step S110), the gateway device 101 determines that a traffic abnormality occurs in the detection target bus (step S114).

Next, the gateway device 101 transmits alarm information indicating the occurrence of the traffic abnormality in the detection target bus, to the on-vehicle devices in the target vehicle or a higher-order device outside the target vehicle (step S116).

Next, the gateway device 101 performs a process of acquiring a communication load Lt+1 of the detection target bus at the next acquisition timing t+1 (step S106), a process of comparing the communication load Lt+1 with the threshold value ThA1 (step S108), and the like.

In the on-vehicle communication system 301 according to the first embodiment of the present disclosure, the gateway device 101 detects a traffic abnormality in the detection target bus. However, the present disclosure is not limited thereto. In the on-vehicle communication system 301, a detection device other than the gateway device 101 may detect a traffic abnormality in the detection target bus.

In the on-vehicle communication system according to the first embodiment of the present disclosure, the gateway device 101 functioning as a detection device is directly connected to the bus 13. However, the present disclosure is not limited thereto.

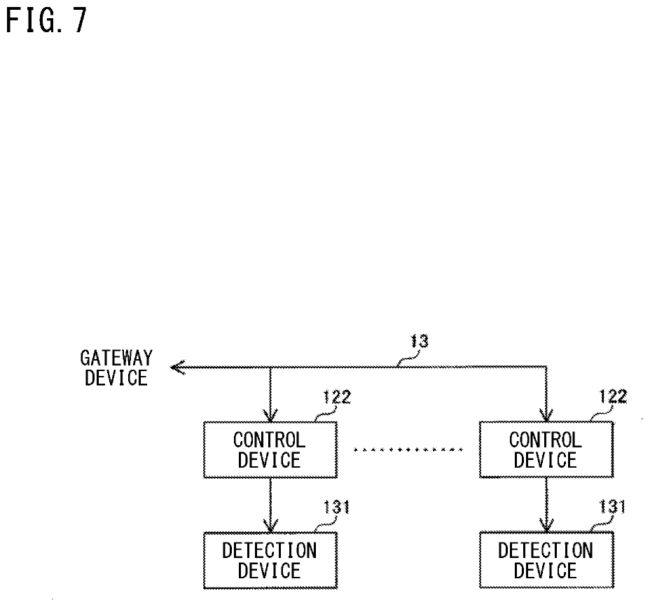

FIG. 7 shows an example of a connection topology of the on-vehicle network according to the first embodiment of the present disclosure.

With reference to FIG. 7, each of detection devices 131 may be connected to the bus 13 via an on-vehicle device, e.g., a control device 122. In this case, the detection device 131 may monitor a message transmitted/received by the on-vehicle device, thereby detecting a traffic abnormality in the bus 13 to which the detection device 131 is connected via the on-vehicle device.

In the example shown in FIG. 7, for example, the monitoring unit 52 in the detection device 131 acquires the total amount of data of messages per unit time period that are transmitted by the control device 122 via the bus 13, and divides the acquired total amount of data by the maximum communication traffic of the bus 13, thereby calculating the communication load L of the bus.

Meanwhile, in the gateway device 101 according to the first embodiment of the present disclosure, the detection unit 54 performs the detection process for, as a detection target bus, a bus 13 connecting control devices 122. However, the present disclosure is not limited thereto. The detection unit 54 may perform the detection process for, as detection target buses, buses 13, 14 connecting a control device 122 and an on-vehicle communication device 111, or may perform the detection process for, as a detection target bus, a bus 14 connecting on-vehicle communication devices 111.

The detection unit 54 may perform the detection process for all the buses 13, 14 in the on-vehicle network 12 as detection targets in parallel, or may perform the detection process for the respective buses 13, 14 as detection targets in a time division manner.

In the gateway device 101 according to the first embodiment of the present disclosure, the detection unit 54 determines whether or not there is a traffic abnormality in the detection target bus, as the process of detecting an abnormality in the on-vehicle network 12. However, the present disclosure is not limited thereto. The detection unit 54 may calculate a probability that the communication traffic in the detection target bus is abnormal, as the process of detecting an abnormality in the on-vehicle network 12.

In the gateway device 101 according to the first embodiment of the present disclosure, the detection unit 54 detects a traffic abnormality, based on the communication load Lt acquired at the acquisition timing t and on the threshold value ThA1. However, the present disclosure is not limited thereto. The detection unit 54 may detect a traffic abnormality, based on the communication load Lt and two or more threshold values. For example, with reference to FIG. 5, the detection unit 54 may set, as a threshold value, the lower-limit value A1 of the reliable section of the average value of the communication load L in the case where the communication traffic is normal, or may set, as a threshold value, an upper-limit value of another reliable section.

The detection unit 54 in the gateway device 101 according to the first embodiment of the present disclosure may not necessarily perform the detection process when the detection unit 54 receives from the user command information indicating that the detection process should be stopped.

In the above configuration, the detection process can be stopped when, for example, the gateway device 101 receives an update program for the firmware, whereby the processing load of the CPU or the like can be reduced.

In the gateway device 101 according to the first embodiment of the present disclosure, the storage unit 56 is a nonvolatile memory. However, the storage unit 56 is not limited thereto. The storage unit 56 may be a volatile memory, or may have a volatile storage region and a nonvolatile storage region.

In the abnormality detection device disclosed in PATENT LITERATURE 1, in order to determine whether or not the feature vector deviates from the reference, a complicated process, such as calculating a nearest neighbor distance, of the feature vector, with respect to a reference indicated by a predetermined model represented by a data structure such as a kd-tree and comparing the nearest neighbor distance with a threshold value, is required, and therefore, the load on the CPU or the like is large. Meanwhile, in the security device disclosed in PATENT LITERATURE 2, in order to determine whether or not the reception interval between the two frames having the same ID is outside the predetermined allowable range, transmission times of the respective frames need to be acquired, and therefore, the load on the CPU or the like is large.

In contrast to the above devices, the detection device according to the first embodiment of the present disclosure detects an abnormality in the on-vehicle network 12 including a plurality of on-vehicle devices. The monitoring unit 52 monitors transmission messages in the on-vehicle network 12, and acquires the communication load L of the detection target bus in the on-vehicle network 12. The acquisition unit 53 acquires the history of the communication load L of the detection target bus in the on-vehicle network to which the acquisition unit 53 belongs, or another on-vehicle network. The detection unit 54 detects a traffic abnormality in the detection target bus, based on the history of the communication load L acquired by the acquisition unit 53 and on the communication load Lt acquired by the monitoring unit 52 at the acquisition timing t after the history of the communication load L.

For example, if a traffic abnormality occurs in the detection target bus, the communication load Lt at the acquisition timing t has a great value. The detection device according to the first embodiment of the present disclosure focuses on the communication load L, and detects a traffic abnormality in the detection target bus, based on the history of the communication load L and the communication load Lt at the acquisition timing t. Therefore, the detection device can detect a traffic abnormality in the detection target bus through a simpler process as compared with the abnormality detection device disclosed in PATENT LITERATURE 1 and the security device disclosed in PATENT LITERATURE 2.

Therefore, the detection device according to the first embodiment of the present disclosure can accurately detect an abnormality in the on-vehicle network 12 through the simple process.

The gateway device 101 according to the first embodiment of the present disclosure relays messages between the on-vehicle devices in the on-vehicle network 12. The monitoring unit 52 monitors transmission messages in the on-vehicle network 12, and acquires the communication load L of the detection target bus in the on-vehicle network 12. The acquisition unit 53 acquires the history of the communication load L of the detection target bus in the on-vehicle network to which the acquisition unit 53 belongs, or another on-vehicle network. The detection unit 54 detects a traffic abnormality in the detection target bus, based on the history of the communication load L acquired by the acquisition unit 53 and on the communication load Lt acquired by the monitoring unit 52 at the acquisition timing t after the history of the communication load L.

For example, if a traffic abnormality occurs in the detection target bus, the communication load Lt at the acquisition timing t has a great value. The detection device according to the first embodiment of the present disclosure focuses on the communication load L, and detects a traffic abnormality in the detection target bus, based on the history of the communication load L and the communication load Lt at the acquisition timing t. Therefore, the detection device can detect a traffic abnormality in the detection target bus through a simpler process as compared with the abnormality detection device disclosed in PATENT LITERATURE 1 and the security device disclosed in PATENT LITERATURE 2.

Therefore, in the gateway device 101 according to the first embodiment of the present disclosure, an abnormality in the on-vehicle network 12 can be accurately detected through the simple process.

In the detection method according to the first embodiment of the present disclosure, firstly, the detection device monitors transmission messages in the on-vehicle network, and acquires the communication load L of the detection target bus in the on-vehicle network 12. Next, the detection device acquires the history of the communication load L of the detection target bus in the on-vehicle network to which the detection device belongs, or another on-vehicle network. Next, the detection device detects a traffic abnormality in the detection target bus, based on the history of the acquired communication load L and on the communication load Lt at the acquisition timing t after the history of the communication load L.

For example, if a traffic abnormality occurs in the detection target bus, the communication load Lt at the acquisition timing t has a great value. The detection device according to the first embodiment of the present disclosure focuses on the communication load L, and detects a traffic abnormality in the detection target bus, based on the history of the communication load L and the communication load Lt at the acquisition timing t. Therefore, the detection device can detect a traffic abnormality in the detection target bus through a simpler process as compared with the abnormality detection device disclosed in PATENT LITERATURE 1 and the security device disclosed in PATENT LITERATURE 2.

Therefore, in the detection method according to the first embodiment of the present disclosure, an abnormality in the on-vehicle network 12 can be accurately detected through the simple process.

In the detection method according to the first embodiment of the present disclosure, firstly, the gateway device 101 monitors transmission messages in the on-vehicle network, and acquires the communication load L of the detection target bus in the on-vehicle network 12. Next, the gateway device 101 acquires the history of the communication load L of the detection target bus in the on-vehicle network to which the gateway device 101 belongs, or another on-vehicle network. Next, the gateway device 101 detects a traffic abnormality in the detection target bus, based on the history of the acquired communication load L and on the communication load Lt at the acquisition timing t after the history of the communication load L.

For example, if a traffic abnormality occurs in the detection target bus, the communication load Lt at the acquisition timing t has a great value. The detection device according to the first embodiment of the present disclosure focuses on the communication load L, and detects a traffic abnormality in the detection target bus, based on the history of the communication load L and the communication load Lt at the acquisition timing t. Therefore, the detection device can detect a traffic abnormality in the detection target bus through a simpler process as compared with the abnormality detection device disclosed in PATENT LITERATURE 1 and the security device disclosed in PATENT LITERATURE 2.

Therefore, in the detection method according to the first embodiment of the present disclosure, an abnormality in the on-vehicle network 12 can be accurately detected through the simple process.

Next, another embodiment of the present disclosure will be described with reference to the drawings. In the drawings, the same or corresponding parts are denoted by the same reference signs, and descriptions thereof are not repeated.

### Second Embodiment

In contrast to the gateway device according to the first embodiment, a gateway device according to a second embodiment detects an abnormality in the on-vehicle network 12 by using a moving average of time series data of a communication load L. The content other than that described below is the same as described with respect to the gateway device according to the first embodiment.

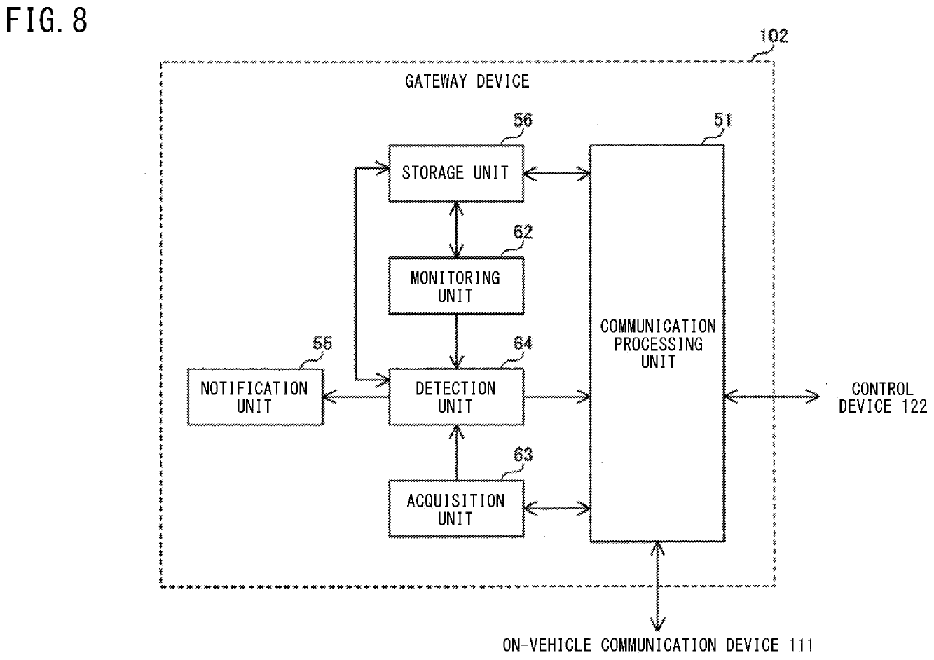

FIG. 8 shows a configuration of the gateway device according to the second embodiment of the present disclosure.

With reference to FIG. 8, a gateway device 102 includes a communication processing unit 51, a monitoring unit 62, an acquisition unit 63, a detection unit 64, a notification unit 55, and a storage unit 56.

The operations of the communication processing unit 51 and the notification unit 55 in the gateway device 102 are identical to the operations of the communication processing unit 51 and the notification unit 55 in the gateway device 101 shown in FIG. 3.

[Monitoring Unit]

The monitoring unit 62 calculates, as a communication load L at a first timing, a moving average of time series data of a communication load L.

For example, the storage unit 56 stores therein setting information indicating, for example, an acquisition cycle Cl of the communication load L, and a window size for calculation of a moving average of time series data of the communication load L. The monitoring unit 62 acquires the setting information from the storage unit 56. According to the acquired setting information, the monitoring unit 62 acquires the communication load L of the detection target bus and calculates a moving average A of time series data of the communication load L at an acquisition timing based on the acquisition cycle Cl.

For example, the monitoring unit 62 acquires a communication load Lt of the detection target bus at an acquisition timing t based on the acquisition cycle Cl, and stores the acquired communication load Lt as one of time series data into the storage unit 56. Furthermore, the monitoring unit 62 acquires, from among the time series data of the communication loads L stored in the storage unit 56, communication loads L which are as many as the number indicated by the window size included in the setting information and are at the most recent acquisition timings, and calculates an average of the acquired communication loads L as a moving average A of the time series data of the communication load L.

In the description below, a moving average A, which is newly calculated by the monitoring unit 62 in accordance with acquisition of a communication load Lt at an acquisition timing t, is referred to as a moving average At. The monitoring unit 62 outputs, to the detection unit 54, the moving average At calculated in accordance with acquisition of the communication load Lt at the acquisition timing t.

[Acquisition Unit]

The acquisition unit 63 acquires the history of the communication load L in the on-vehicle network to which the acquisition unit 63 belongs, or another on-vehicle network. More specifically, the acquisition unit 63 acquires the history of the moving average A acquired by the monitoring unit 62.

For example, the acquisition unit 63 acquires, as the history of the moving average A, distribution information F2 indicating a frequency distribution of the moving average A created in advance by another device such as a server.

Based on the moving average A for each bus 13 acquired over a certain time period by the monitoring unit 62, the server creates, for each bus 13, a frequency distribution D2 of the moving average A. This moving average A is acquired in a test vehicle of the same type as the target vehicle, i.e., in another on-vehicle network. The server may create the frequency distribution D2 based on the moving average A acquired in the target vehicle, that is, in the on-vehicle network of the target vehicle.

Based on the created frequency distribution D2, the server calculates a sample average, a sample standard deviation, etc., of the moving average A. When the server receives, from the acquisition unit 63, a transmission request for the distribution information F2, the server transmits, to the target vehicle as a request source, the distribution information F2 including the sample average, the sample standard deviation, etc., of the moving average A.

Referring back to FIG. 8, the acquisition unit 63 transmits, to the server, the transmission request for the distribution information F2 of the detection target bus, thereby acquiring the distribution information F2. The acquisition unit 63 receives the distribution information F2 from the server via the on-vehicle communication device 111 and the communication processing unit 51, and outputs the received distribution information F2 to the detection unit 54.

[Detection Unit]

The detection unit 64 detects a traffic abnormality in the detection target bus, based on the history of the moving average A acquired by the acquisition unit 63 and on the moving average At that is calculated by the monitoring unit 62 at the acquisition timing t after the acquisition timing of each moving average A included in the history.

For example, the detection unit 64 detects a traffic abnormality in the detection target bus, based on the distribution information F2 received from the acquisition unit 63 and on the moving average At received from the monitoring unit 62.

More specifically, upon receiving the distribution information F2 from the acquisition unit 63, the detection unit 64 calculates, based on the distribution information F2, a lower-limit value A2 and an upper-limit value B2 of a reliable section of an average value of the moving average A in the case where the communication traffic is normal, and sets the calculated upper-limit value B2 as a threshold value ThA2.

The detection unit 64 receives the moving average At from the monitoring unit 62, and compares the received moving average At with the threshold value ThA2.

Based on the moving average At and the threshold value ThA2, the detection unit 54 determines whether or not a traffic abnormality occurs in the detection target bus, and outputs determination information indicating the determination result to the communication processing unit 51 and the notification unit 55.

[Operation]

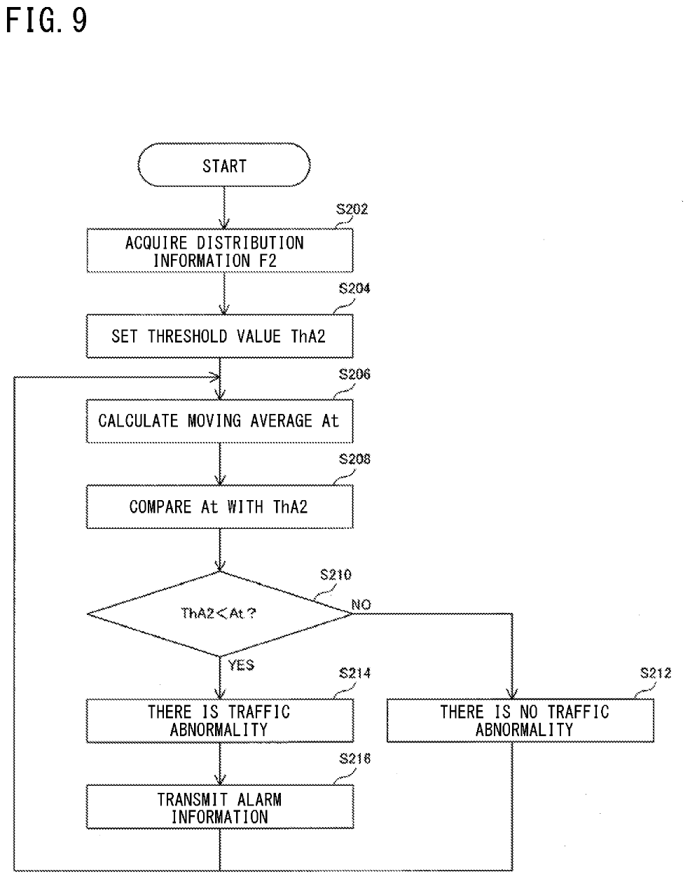

FIG. 9 is a flowchart of an operation procedure when the gateway device according to the second embodiment of the present disclosure performs detection of a traffic abnormality in a detection target bus.

With reference to FIG. 9, firstly, the gateway device 102 acquires distribution information F2 indicating a frequency distribution D2 of a moving average A of the detection target bus (step S202).

Next, the gateway device 102 sets a threshold value ThA2, based on the distribution information F2 (step S204).

Next, the gateway device 102 acquires a communication load Lt of the detection target bus at an acquisition timing t, and calculates a moving average At (step S206).

Next, the gateway device 102 compares the calculated moving average At with the set threshold value ThA2 (step S208).

When the moving average At is equal to or smaller than the threshold value ThA2 (NO in step S210), the gateway device 102 determines that no traffic abnormality occurs in the detection target bus and the communication traffic is normal (step S212).

Next, the gateway device 102 performs a process of calculating a moving average At+1 of the detection target bus at the next acquisition timing t+1 (step S206), a process of comparing the moving average At+1 with the threshold value ThA2 (step S208), and the like.

On the other hand, when the moving average At is greater than the threshold value ThA2 (YES in step S210), the gateway device 102 determines that a traffic abnormality occurs in the detection target bus (step S214).

Next, the gateway device 102 transmits alarm information indicating the occurrence of the traffic abnormality in the detection target bus, to the on-vehicle devices in the target vehicle or a higher-order device outside the target vehicle (step S216).

Next, the gateway device 102 performs a process of calculating a moving average At+1 of the detection target bus at the next acquisition timing t+1 (step S206), a process of comparing the moving average At+1 with the threshold value ThA2 (step S208), and the like.

In the on-vehicle communication system 301 according to the second embodiment of the present disclosure, the acquisition unit 63 acquires the distribution information F2 indicating the frequency distribution D2 of the moving average A. However, the present disclosure is not limited thereto. As in the case of the acquisition unit 53 according to the first embodiment of the present disclosure, the acquisition unit 63 may acquire distribution information F1 indicating a frequency distribution D1 of a communication load L.

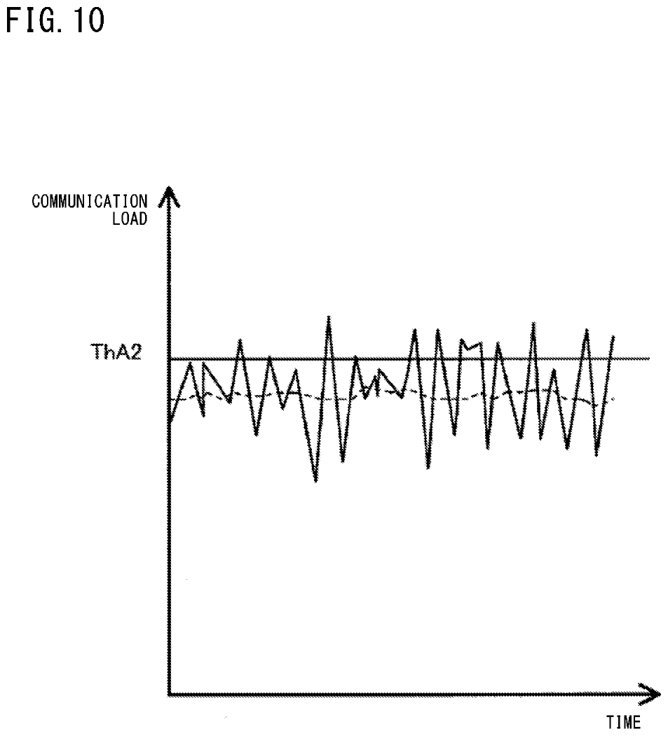

FIG. 10 shows an example of temporal change in communication load in the on-vehicle communication system according to the second embodiment of the present disclosure. In FIG. 10, the vertical axis represents communication load L and the horizontal axis represents time. In FIG. 10, a solid line represents a communication load Lt of the detection target bus acquired by the monitoring unit 62 at each acquisition timing t, and a broken line represents a moving average At calculated by the monitoring unit 62 at each acquisition timing t.

With reference to FIG. 10, the communication load Lt of the detection target bus is not constant but varies. Therefore, for example, in the case where the monitoring unit 62 outputs the communication load Lt at each acquisition timing t as it is to the detection unit 64, even if no traffic abnormality occurs in the detection target bus, the detection unit 64 may erroneously determine, as a result of comparison of the communication load Lt with the threshold value ThA2, that the communication load Lt exceeds the threshold value ThA2 and a traffic abnormality occurs in the detection target bus.

Meanwhile, in the detection device according to the second embodiment, the monitoring unit 62 calculates the moving average At of the communication load L of the detection target bus, as the communication load Lt of the detection target bus at the acquisition timing t. The monitoring unit 62 outputs the calculated moving average At to the detection unit 64. The detection unit 64 compares the received moving average At with the threshold value ThA2, and detects a traffic abnormality in the detection target bus, based on the comparison result.

In the above configuration, the result of comparison between the threshold value ThA2 and the moving average At having less variation than the communication load Lt, can be used for detection of a traffic abnormality in the detection target bus. Thus, a traffic abnormality in the detection target bus can be detected more accurately.

Since other components and operations are identical to those of the on-vehicle communication system 301 according to the first embodiment, detailed descriptions thereof are not repeated.

Next, another embodiment of the present disclosure will be described with reference to the drawings. In the drawings, the same or corresponding parts are denoted by the same reference signs, and descriptions thereof are not repeated.

### Third Embodiment

In contrast to the gateway device according to the second embodiment, a gateway device according to a third embodiment estimates occurrence of an unauthorized message in the on-vehicle network 12, by using an estimation value of a communication load Lt at an acquisition timing t. The content other than that described below is the same as described with respect to the gateway device according to the first embodiment.

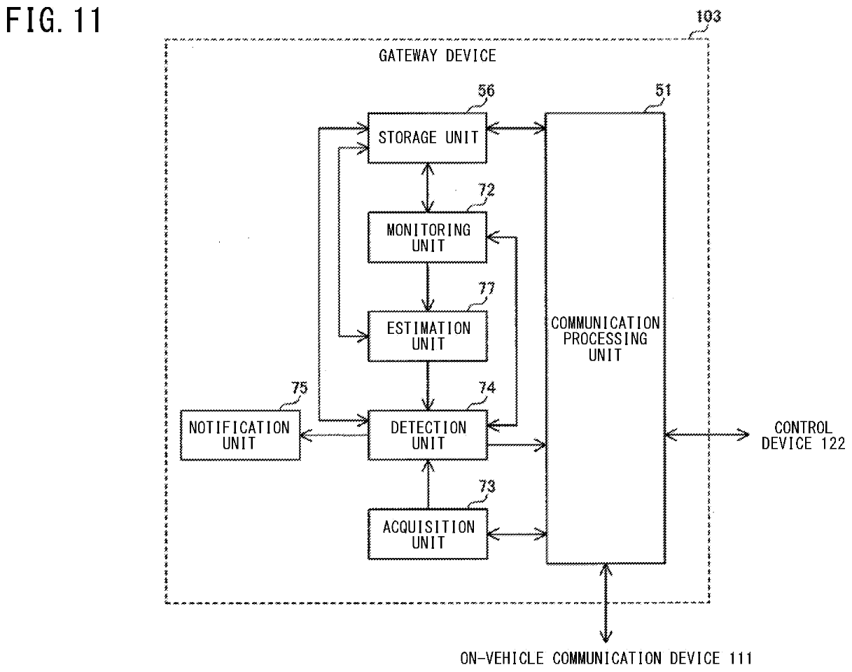

FIG. 11 shows a configuration of the gateway device according to the third embodiment of the present disclosure.

With reference to FIG. 11, the gateway device 103 includes a communication processing unit 51, a monitoring unit 72, an acquisition unit 73, a detection unit 74, a notification unit 75, a storage unit 56, and an estimation unit 77.

The operation of the communication processing unit 51 in the gateway device 103 is identical to the operation of the communication processing unit 51 in the gateway device 101 shown in FIG. 3.

As in the case of the monitoring unit 62 of the second embodiment, the monitoring unit 72 acquires a communication load Lt at each acquisition timing t and calculates a moving average At.

The monitoring unit 72 outputs the acquired communication load Lt and the calculated moving average At to the detection unit 74 and the estimation unit 77, and stores them in the storage unit 56.

[Estimation Unit]

The estimation unit 77 calculates an estimation value P of a communication load L at a first timing, based on a communication load L acquired by the monitoring unit 72 at a timing before the first timing.

More specifically, the estimation unit 77 calculates an estimation value Pt of a communication load Lt at an acquisition timing t, based on a communication load L acquired at a past timing before the acquisition timing t, by using an autoregressive integrated moving average model (ARIMA model), for example.

For example, the storage unit 56 stores therein setting information indicating, for example, the autoregressive integrated moving average model, and the number of pieces of data of the past communication load L to be used for calculation of the estimation value P. The estimation unit 77 acquires the setting information from the storage unit 56, and calculates an estimation value Pt of a communication load Lt at an acquisition timing t, according to the setting information.

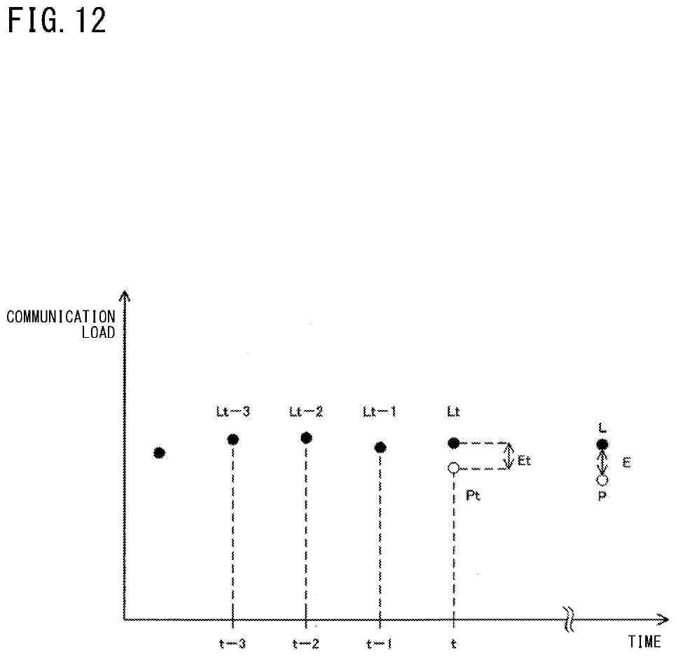

FIG. 12 shows an example of temporal change of communication load in the on-vehicle communication system according to the third embodiment of the present disclosure. In FIG. 12, the vertical axis represents communication load L and the horizontal axis represents time. In FIG. 12, each of black dots indicates a measured value of a communication load L, and each of white dots indicates an estimation value P of a communication load L.

It is assumed that, in the setting information stored in the storage unit 56, “3” is set as the number of pieces of data of the past communication load L to be used for calculation of the estimation value P.

With reference to FIG. 12, the estimation unit 77 receives a communication load Lt−1 at an acquisition timing t−1 from the monitoring unit 72, and acquires, from the storage unit 56, a communication load Lt−2 at the last acquisition timing t−2 and a communication load Lt−3 at the second last acquisition timing t−3.

The estimation unit 77 calculates an estimation value Pt of a communication load Lt at the next acquisition timing t, based on the communication loads Lt−1, Lt−2, and Lt−3.

More specifically, the estimation unit 77 calculates the estimation value Pt of the communication load Lt at the acquisition timing t according to the following formula (1), and outputs the calculated estimation value Pt to the detection unit 74.

$$\begin{matrix}[ Math . 1 ] \\ & \\ Pt = {y}_{t - 1} + {\sum }_{k = 1}^{A} {φ}_{k} \{ {y}_{t - k} - B ( {y}_{t - ( k + 1 )} ) \} + {\sum }_{k = 1}^{C} {θ}_{k} {ɛ}_{t - k} + Constant & ( 1 )\end{matrix}$$

In formula (1), Pt is the estimation value of the communication load of the detection target bus at the acquisition timing t, yt is the measured value of the communication load of the detection target bus at the acquisition timing t, φ, θ, and B are appropriate parameters discretionarily set in advance, c is an error term, A is the order of autoregressive model, and C is the order of moving average.

[Acquisition Unit]

As in the case of the acquisition unit 63 of the second embodiment, the acquisition unit 73 acquires the history of the moving average A acquired by the monitoring unit 72.

Referring back to FIG. 12, the acquisition unit 73 acquires the history of a value E (hereinafter, also referred to as “error E”) obtained by subtracting the estimation value P, corresponding to the communication load L, calculated by the estimation unit 77 from the communication load L acquired by the monitoring unit 72.

The acquisition unit 73 acquires, as the history of the error E, distribution information F3 indicating a frequency distribution of the error E created in advance by another device such as a server.

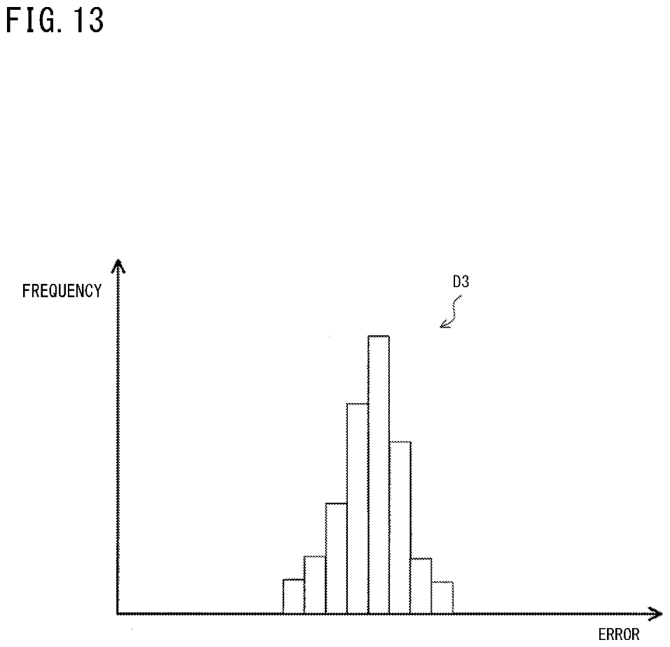

FIG. 13 shows an example of a frequency distribution of error of communication load in the on-vehicle communication system according to the third embodiment of the present disclosure. In FIG. 13, the vertical axis represents frequency and the horizontal axis represents error E.

With reference to FIG. 13, the server creates, for each bus 13, a frequency distribution D3 of error E, based on the communication load L, of each bus 13, acquired over a certain time period by the monitoring unit 72 and on the corresponding estimation value P calculated by the estimation unit 77. This error E is acquired in a test vehicle of the same type as the target vehicle, i.e., in another on-vehicle network, for example. The server may create the frequency distribution D3 based on the error E acquired in the target vehicle, that is, in the on-vehicle network of the target vehicle.

Based on the created frequency distribution D3, the server calculates a sample average, a sample standard deviation, etc., of the error E. Upon receiving, from the acquisition unit 73, a transmission request for the distribution information F3, the server transmits the distribution information F3 including the sample average, the sample standard deviation, etc., of the error E to the target vehicle having transmitted the request.

Referring back to FIG. 11, the acquisition unit 73 transmits, to the server, the transmission request for the distribution information F3 of the detection target bus, thereby acquiring the distribution information F3. The acquisition unit 73 receives the distribution information F3 from the server via the on-vehicle communication device 111 and the communication processing unit 51, and outputs the received distribution information F3 to the detection unit 54.

In the gateway device 103, the acquisition unit 73 receives the distribution information F3 from the server via the on-vehicle communication device 111 and the communication processing unit 51. However, the present disclosure is not limited thereto. For example, the server or a maintenance terminal device may store the distribution information F3 of each bus 13 into the storage unit 56, and the acquisition unit 53 may acquire the distribution information F3 of the detection target bus from the storage unit 56.

[Detection Unit]

As in the case of the detection unit 64 of the second embodiment, the detection unit 74 detects a traffic abnormality in the detection target bus, based on the history of a moving average A acquired by the acquisition unit 73, and on a moving average At that is calculated by the monitoring unit 72 at an acquisition timing t after the acquisition timing of each moving average A included in the history, and that is acquired by the monitoring unit 72.

Furthermore, the detection unit 74 compares the communication load L at the first timing acquired by the monitoring unit 72 with the estimation value P, of the communication load L at the first timing, calculated by the estimation unit 77, and estimates occurrence of an unauthorized message in the on-vehicle network 12, based on the comparison result.

More specifically, the detection unit 74 calculates an error Et which is a difference between a communication load Lt acquired at an acquisition timing t by the monitoring unit 72 and the corresponding estimation value Pt calculated by the estimation unit 77, and estimates occurrence of an unauthorized message in the detection target bus, based on the calculated error Et.

For example, the detection unit 74 estimates occurrence of an unauthorized message in the detection target bus, based on the distribution information F3 received from the acquisition unit 73, the communication load Lt received from the monitoring unit 72, and the estimation value Pt received from the estimation unit 77.

More specifically, it can be assumed that the frequency distribution D3 created by the server is a frequency distribution of error E obtained when no unauthorized message occurs in the detection target bus. The detection unit 74 estimates occurrence of an unauthorized message in the detection target bus, based on the distribution information F3 corresponding to the frequency distribution D3 and on the error Et which is calculated based on the communication load Lt received from the monitoring unit 72 and the estimation value Pt received from the estimation unit 77.

For example, based on the distribution information F3 received from the acquisition unit 73, the detection unit 74 creates, as a model, a probability density function by approximating the frequency distribution of the error E with a normal distribution. Then, based on the created model and the calculated error Et, the detection unit 74 estimates occurrence of an unauthorized message in the detection target bus.

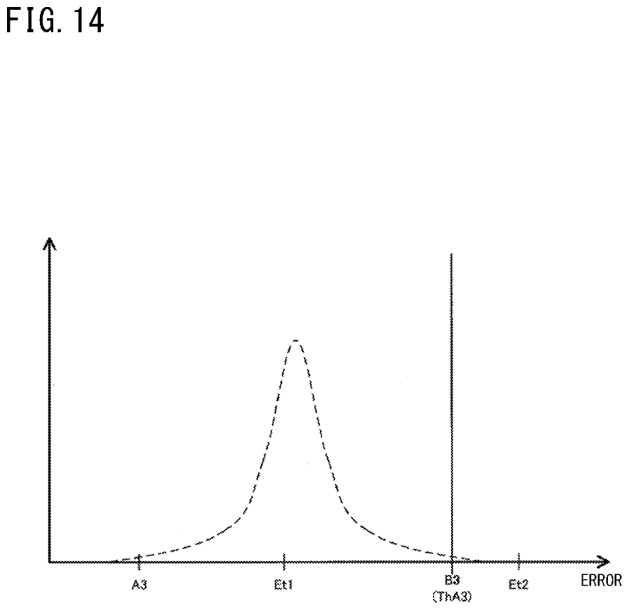

FIG. 14 shows an example of estimation of occurrence of an unauthorized message by the detection unit in the gateway device according to the third embodiment of the present disclosure. In FIG. 14, the horizontal axis represents difference. In FIG. 14, a broken line indicates a probability density function obtained by approximating the frequency distribution D3 of the error E with the normal distribution.

With reference to FIG. 11 and FIG. 14, the detection unit 74 receives the distribution information F3 from the acquisition unit 73, and calculates, based on the distribution information F3, a lower-limit value A3 and an upper-limit value B3 of a reliable section of an average value of the error E in the case where no unauthorized message occurs, and sets the calculated upper-limit value B3 as a threshold value ThA3.

The detection unit 74 receives the communication load Lt from the monitoring unit 72, and receives the estimation value Pt corresponding to the communication load Lt from the estimation unit 77. Then, the detection unit 74 calculates, as an error Et, a difference between the communication load Lt and the estimation value Pt, and compares the calculated error Et with the threshold value ThA3.

For example, when an error Et1 corresponding to an acquisition timing t1 is equal to or smaller than the threshold value ThA3, the detection unit 74 estimates that no unauthorized message occurs in the detection target bus.

The reason is as follows. That is, for example, when no unauthorized message occurs in the detection target bus at the acquisition timing t1, the error Et1 is highly likely to be positioned near the center of the probability density function shown in FIG. 14 and therefore is less likely to exceed the threshold value ThA3.

On the other hand, when an error Et2 corresponding to an acquisition timing t2 is greater than the threshold value ThA3, the detection unit 74 estimates that an unauthorized message occurs in the detection target bus.

The reason is as follows. That is, for example, when an unauthorized message occurs in the detection target bus at the acquisition timing t2, the error Et2 has a great value and therefore is highly likely to exceed the threshold value ThA3.

The detection unit 74 outputs estimation information indicating an estimation result based on the error Et and the threshold value ThA3 to the communication processing unit 51, the monitoring unit 72, and the notification unit 75.

When the estimation information received from the detection unit 74 indicates that no unauthorized message occurs in the detection target bus, the communication processing unit 51 transmits a message to the control device 122 as a destination via the detection target bus.

On the other hand, when the estimation information received from the detection unit 74 indicates that an unauthorized message occurs in the detection target bus, the communication processing unit 51 stops the relay process via the detection target bus, for example. Then, the communication processing unit 51 records, as a log, the message and the detection target bus indicated by the estimation information into the storage unit 56.

When the estimation information received from the detection unit 74 indicates that an unauthorized message occurs in the detection target bus, the notification unit 75 transmits alarm information indicating the occurrence of the unauthorized message in the detection target bus, to the on-vehicle devices in the target vehicle or a higher-order device outside the target vehicle.

The notification unit 75 outputs a first alarm information Ar1 when an abnormality in the on-vehicle network 12 is detected by the detection unit 74, and outputs a second alarm information Ar2 different from the first alarm information Ar1 when occurrence of an unauthorized message in the on-vehicle network 12 is estimated by the detection unit 74.

For example, the alarm information indicates the degree of emergency. Upon receiving the alarm information, an on-vehicle device in the target vehicle notifies a user of the degree of emergency indicated by the alarm information through a display device or the like. The notification unit 75 transmits two types of alarm information having different degrees of emergency, between the case where determination information indicating occurrence of a traffic abnormality in the detection target bus is received and the case where estimation information indicating occurrence of an unauthorized message in the detection target bus is received.

When occurrence of an unauthorized message is estimated by the detection unit 74, the estimation unit 77 calculates an estimation value P at a second timing after the first timing, based on the communication load L acquired at a timing on or after the first timing.

More specifically, upon receiving, from the detection unit 74, the estimation information indicating occurrence of an unauthorized message in the detection target bus, the estimation unit 77 discards the communication loads L acquired at timings before the timing when an error E exceeding the threshold value ThA3 was calculated, and calculates a new estimation value P based on the communication load L acquired at the timing when the error E exceeding the threshold value ThA3 was calculated or subsequent timing.

Furthermore, upon receiving, from the detection unit 74, the estimation information indicating occurrence of an unauthorized message in the detection target bus, the monitoring unit 72 calculates a new moving average A based on the communication load L acquired at a timing on or after the timing when the error E exceeding the threshold value ThA3 was calculated.

[Operation]

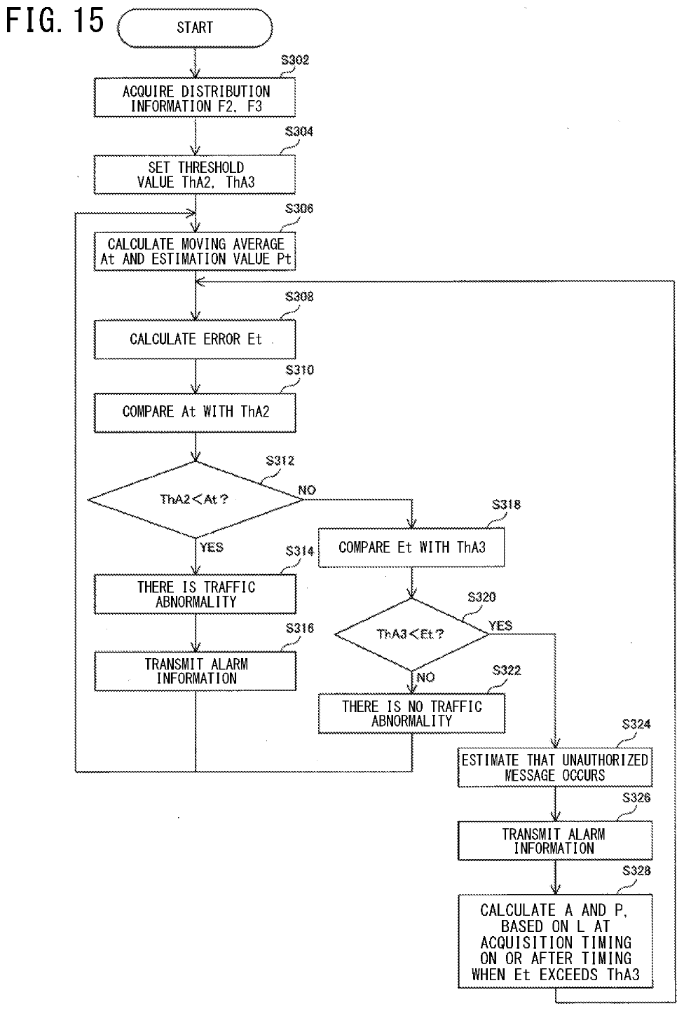

FIG. 15 is a flowchart of an operation procedure when the gateway device according to the third embodiment of the present disclosure performs detection of a traffic abnormality in a detection target bus and estimation of occurrence of an unauthorized message in the detection target bus.

With reference to FIG. 15, firstly, the gateway device 103 acquires distribution information F2 indicating a frequency distribution D2 of a moving average A of the detection target bus, and distribution information F3 indicating a frequency distribution D3 of an error E (step S302).

Next, the gateway device 103 sets a threshold value ThA2 based on the distribution information F2, and sets a threshold value ThA3 based on the distribution information F3 (step S304).

Next, the gateway device 103 acquires a communication load Lt of the detection target bus at an acquisition timing t, and calculates a moving average At and an estimation value Pt (step S306).

Next, the gateway device 103 calculates an error Et, based on the communication load Lt and the estimation value Pt (step S308).

Next, the gateway device 103 compares the moving average At with the threshold value ThA2 (step S310).

When the moving average At is greater than the threshold value ThA2 (YES in step S312), the gateway device 103 determines that a traffic abnormality occurs in the detection target bus (step S314).

Next, the gateway device 103 transmits alarm information indicating the occurrence of the traffic abnormality in the detection target bus, to the on-vehicle devices in the target vehicle or a higher-order device outside the target vehicle (step S316).

Next, the gateway device 103 performs a process of acquiring a communication load Lt+1 at the next acquisition timing t+1 and calculating a moving average At+1 and an estimation value Pt+1 (step S306), a process of calculating an error Et+1 (step S308), and the like.

On the other hand, when the moving average At is equal to or smaller than the threshold value ThA2 (NO in step S312), the gateway device 103 compares the error Et with the threshold value ThA3 (step S318).

When the error Et is equal to or smaller than the threshold value ThA3 (NO in step S320), the gateway device 103 determines that no traffic abnormality occurs in the detection target bus and estimates that no unauthorized message occurs (step S322).

Next, the gateway device 103 performs a process of acquiring a communication load Lt+1 at the next acquisition timing t+1 and calculating a moving average At+1 and an estimation value Pt+1 (step S306), a process of calculating an error Et+1 (step S308), and the like.

On the other hand, when the error Et is greater than the threshold value ThA3 (YES in step S320), the gateway device 103 estimates that an unauthorized message occurs in the detection target bus (step S324).

Next, the gateway device 103 transmits alarm information indicating the occurrence of the unauthorized message in the detection target bus, to the on-vehicle devices in the target vehicle or a higher-order device outside the target vehicle (step S326).

Next, the gateway device 103 calculates a moving average At+1 and an estimation value Pt+1 at the next acquisition timing t+1, based on the communication load L acquired at an acquisition timing on or after the current acquisition timing t (step S328).

Next, the gateway device 103 performs a process of calculating an error Et+1 based on the communication load Lt+1 and the estimation value Pt+1 (step S308), a process of comparing the moving average At+1 with the threshold value ThA2 (step S310), and the like.

In the on-vehicle communication system 301 according to the third embodiment of the present disclosure, the estimation unit 77 calculates the estimation value P, based on the communication load L at the past timing. However, the present disclosure is not limited thereto. The estimation unit 77 may calculate the estimation value P, based on the moving average A at the past timing.

In the on-vehicle communication system 301 according to the third embodiment of the present disclosure, as in the case of the detection unit 64 in the on-vehicle communication system 301 according to the second embodiment, the detection unit 74 detects a traffic abnormality in the detection target bus, based on the history of the moving average A and the moving average At. However, the present disclosure is not limited thereto. As in the case of the detection unit 54 in the on-vehicle communication system 301 according to the first embodiment, the detection unit 74 may detect a traffic abnormality in the detection target bus, based on the history of the communication load L and on the communication load Lt.

<Modifications>

In the on-vehicle communication system 301 according to the third embodiment of the present disclosure, the gateway device 103 detects a traffic abnormality due to an unauthorized message in the detection target bus, as a process of detecting an abnormality in the on-vehicle network 12. However, the present disclosure is not limited thereto.

The gateway device 103 may estimate occurrence of an unauthorized message in the detection target bus, as the process of detecting an abnormality in the on-vehicle network 12.

More specifically, when the gateway device 103 has estimated occurrence of an unauthorized message in the detection target bus, the gateway device 103 may determine that an abnormality occurs in the on-vehicle network 12.

In the on-vehicle communication system 301 according to the third embodiment of the present disclosure, the detection unit 74 detects a traffic abnormality in the detection target bus, based on the history of the moving average A and on the moving average At, and estimates occurrence of an unauthorized message in the detection target bus, based on the error Et which is a difference between the communication load Lt and the estimation value Pt. However, the present disclosure is not limited thereto.

The detection unit 74 may not necessarily detect a traffic abnormality in the detection target bus, based on the history of the moving average A and the moving average At, while estimating occurrence of an unauthorized message in the detection target bus, based on the error Et.

In this case, the acquisition unit 73 may not necessarily acquire the history of the moving average A, while acquiring the history of the error E.

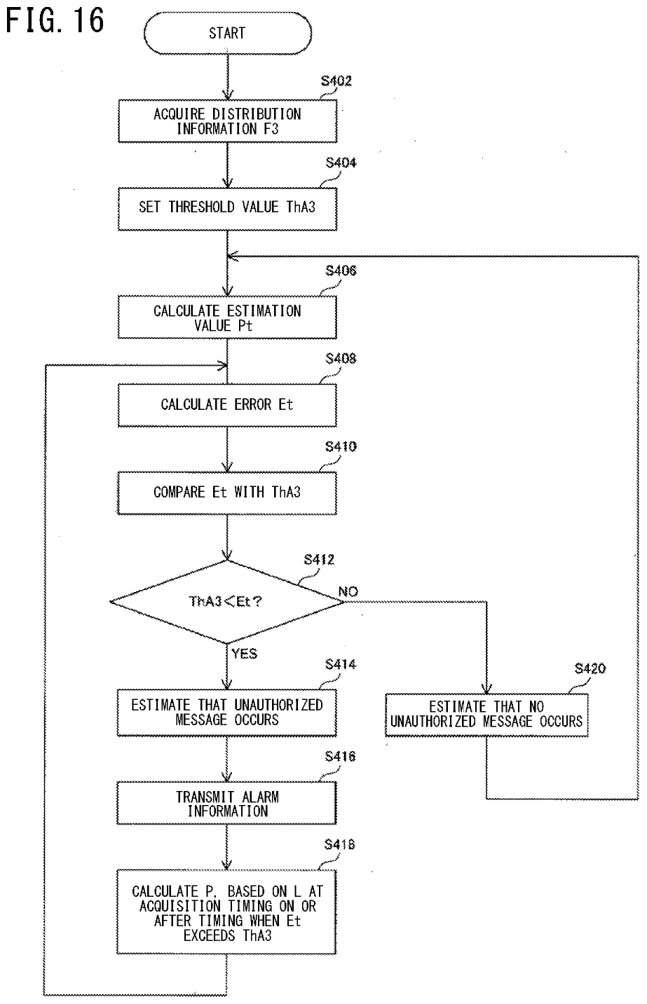

FIG. 16 is a flowchart of an operation procedure when the gateway device according to the modification of the third embodiment of the present disclosure estimates occurrence of an unauthorized message in the detection target bus.

With reference to FIG. 16, firstly, the gateway device 103 acquires distribution information F3 indicating a frequency distribution D3 of an error E of the detection target bus (step S402).

Next, the gateway device 103 sets a threshold value ThA3 based on the distribution information F3 (step S404).

Next, the gateway device 103 acquires a communication load Lt of the detection target bus at an acquisition timing t, and calculates an estimation value Pt (step S406).

Next, the gateway device 103 calculates an error Et, based on the communication load Lt and the estimation value Pt (step S408).

Next, the gateway device 103 compares the error Et with the threshold value ThA3 (step S410).

When the error Et is greater than the threshold value ThA3 (YES in step S412), the gateway device 103 estimates that an unauthorized message occurs in the detection target bus (step S414).

Next, the gateway device 103 transmits alarm information indicating the occurrence of the unauthorized message in the detection target bus, to the on-vehicle devices in the target vehicle or a higher-order device outside the target vehicle (step S416).

Next, the gateway device 103 calculates an estimation value Pt+1 at the next acquisition timing t+1, based on the communication load L acquired at an acquisition timing on or after the current acquisition timing t (step S418).

Next, the gateway device 103 performs a process of calculating an error Et+1 based on the communication load Lt+1 and the estimation value Pt+1 (step S408), a process of comparing the error Et+1 with the threshold value ThA3 (step S410), and the like.

On the other hand, when the error Et is equal to or smaller than the threshold value ThA3 (NO in step S412), the gateway device 103 estimates that no unauthorized message occurs in the detection target bus (step S420).

Next, the gateway device 103 performs a process of acquiring a communication load Lt+1 at the next acquisition timing t+1 and calculating an estimation value Pt+1 (step S406), a process of calculating an error Et+1 (step S408), and the like.

[Problem]

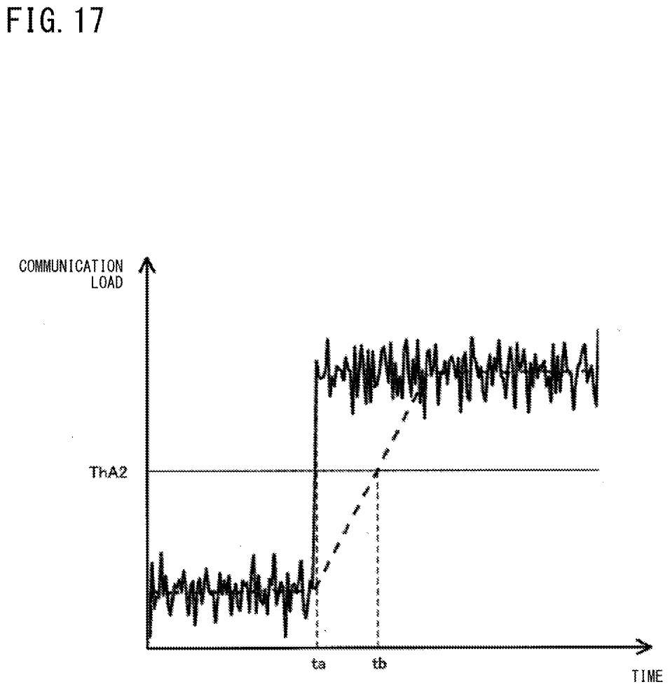

FIG. 17 shows an example of temporal change in communication load in the on-vehicle communication system according to the third embodiment of the present disclosure. In FIG. 17, the vertical axis represents communication load L and the horizontal axis represents time. In FIG. 17, a solid line represents a communication load Lt of the detection target bus acquired by the monitoring unit 72 at each acquisition timing t, and a broken line represents a moving average At calculated by the monitoring unit 72 at each acquisition timing t.

In the gateway device 102 according to the second embodiment of the present disclosure, the detection unit 64 determines whether or not a traffic abnormality occurs in the detection target bus, based on the result of comparison between the moving average At and the threshold value ThA2. In this configuration, timing to transmit the alarm information based on the determination result is sometimes delayed from timing at which transmission of the unauthorized message is actually started.

More specifically, with reference to FIG. 17, it is assumed that transmission of a pseudo unauthorized message to the detection target bus is started at time ta. The moving average At starts to increase at time ta, and exceeds for the first time the threshold value ThA2 at time tb. Therefore, the timing to transmit the alarm information becomes time tb, and a delay occurs from time ta at which transmission of the unauthorized message is actually started.

On the other hand, in the gateway device 103 according to the third embodiment of the present disclosure, the estimation value Pt of the communication load Lt at the acquisition timing t is calculated based on the communication load L at an acquisition timing before the acquisition timing t, and it is estimated whether or not an unauthorized message occurs in the detection target bus, based on the result of comparison between the threshold value ThA3 and the error Et which is a difference between the communication load Lt and the estimation value Pt.

In the above configuration, even when the moving average At at the acquisition timing t does not exceed the threshold value ThA2, it is possible to estimate occurrence of an unauthorized message when the difference between the communication load Lt and the estimation value Pt estimated from the communication load L at a past timing exceeds the threshold value ThA3. Thus, occurrence of an unauthorized message in the detection target bus can be estimated earlier than the timing at which a traffic abnormality in the detection target bus can be detected based on the moving average At.

In the gateway device 103 according to the third embodiment of the present disclosure, when occurrence of an unauthorized message has been estimated by the detection unit 74, the estimation unit 77 calculates a new estimation value P based on the communication load L acquired at a timing on or after the timing when the error E exceeding the threshold value ThA3 was calculated.

In the above configuration, the new estimation value P can be calculated more accurately based on the communication load L acquired at the timing when the communication load L was significantly increased or subsequent timing. Therefore, for example, even when the communication load L is further changed, occurrence of an unauthorized message in the detection target bus can be accurately estimated based on the newly calculated estimation value P.

In the gateway device 103 according to the third embodiment of the present disclosure, the notification unit 75 outputs the first alarm information Ar1 when an abnormality in the on-vehicle network 12 has been detected by the detection unit 74, and outputs the second alarm information Ar2 different from the first alarm information Ar1 when occurrence of an unauthorized message in the on-vehicle network 12 has been estimated.

In the above configuration, the notification unit 75 outputs the different types of alarm information between the case where a traffic abnormality has occurred in the detection target bus and the case where occurrence of an unauthorized message in the detection target bus has been estimated. Thus, it is possible to notify the user of alarms having different degrees of emergency according to the situation, for example.

The detection device according to the third embodiment of the present disclosure detects an abnormality in the on-vehicle network 12 including the plurality of on-vehicle devices. The monitoring unit 72 monitors transmission messages in the on-vehicle network 12, and acquires a communication load L in the on-vehicle network 12. The estimation unit 77 calculates an estimation value P of the communication load L to be acquired by the monitoring unit 72, based on the communication load L acquired in the past by the monitoring unit 72. The acquisition unit 73 acquires the history of an error E which is a difference between a communication load L in an on-vehicle network to which the acquisition unit 73 belongs or in another on-vehicle network, and an estimation value P of the communication load L. The detection unit 74 detects an abnormality in the on-vehicle network, based on: the history of the difference between the communication load L acquired by the acquisition unit 73 and the estimation value P of the communication load L; a communication load Lt, acquired by the monitoring unit 72, at an acquisition timing t after the history of the difference between the communication load L and the estimation value P of the communication load L; and an estimation value Pt, of the communication load Lt at the acquisition timing t, calculated by the estimation unit 77.

For example, when an unauthorized message occurs in the detection target bus, the difference between the communication load Lt at the acquisition timing t and the estimation value Pt has a great value. The detection device according to the third embodiment of the present disclosure focuses on a difference between the communication load Lt and the estimation value Pt, and estimates occurrence of an unauthorized message in the detection target bus, based on the history of the difference between the communication load Lt and the estimation value Pt, the communication load Lt at the acquisition timing t, and the estimation value Pt of the communication load Lt. Thus, the detection device can estimate occurrence of an unauthorized message in the detection target bus through a simpler process as compared with the abnormality detection device described in PATENT LITERATURE 1 and the security device described in PATENT LITERATURE 2.

Therefore, the detection device according to the third embodiment of the present disclosure can accurately detect an abnormality in the on-vehicle network 12 through the simple process.

The gateway device 103 according to the third embodiment of the present disclosure relays messages between the on-vehicle devices in the on-vehicle network 12. The monitoring unit 72 monitors transmission messages in the on-vehicle network 12, and acquires a communication load L in the on-vehicle network 12. The estimation unit 77 calculates an estimation value P of the communication load L to be acquired by the monitoring unit 72, based on the communication load L acquired in the past by the monitoring unit 72. The acquisition unit 73 acquires the history of an error E which is a difference between a communication load L in an on-vehicle network to which the acquisition unit 73 belongs or in another on-vehicle network, and an estimation value P of the communication load L. The detection unit 74 detects an abnormality in the on-vehicle network, based on: the history of the difference between the communication load L acquired by the acquisition unit 73 and the estimation value P of the communication load L; a communication load Lt, acquired by the monitoring unit 72, at an acquisition timing t after the history of the difference between the communication load L and the estimation value P of the communication load L; and an estimation value Pt, of the communication load Lt at the acquisition timing t, calculated by the estimation unit 77.

For example, when an unauthorized message occurs in the detection target bus, the difference between the communication load Lt at the acquisition timing t and the estimation value Pt has a great value. The gateway device 103 according to the third embodiment of the present disclosure focuses on a difference between the communication load Lt and the estimation value Pt, and estimates occurrence of an unauthorized message in the detection target bus, based on the history of the difference between the communication load Lt and the estimation value Pt, the communication load Lt at the acquisition timing t, and the estimation value Pt of the communication load Lt. Thus, the detection device can estimate occurrence of an unauthorized message in the detection target bus through a simpler process as compared with the abnormality detection device described in PATENT LITERATURE 1 and the security device described in PATENT LITERATURE 2.

Therefore, the gateway device 103 according to the third embodiment of the present disclosure can accurately detect an abnormality in the on-vehicle network 12 through the simple process.

Since other components and operations are identical to those of the on-vehicle communication system 301 according to the first embodiment, detailed descriptions thereof are not repeated.

The embodiments disclosed above are merely illustrative in all aspects and should be considered not restrictive. The scope of the present invention is defined by the scope of the claims rather than the meaning described above, and is intended to include meaning equivalent to the scope of the claims and all modifications within the scope.

The above description includes the features in the additional notes below.

### [Additional Note 1]

A detection device configured to detect an abnormality in an on-vehicle network including a plurality of on-vehicle devices, the detection device comprising:

a monitoring unit configured to monitor transmission messages in the on-vehicle network, and calculate a moving average of time series data of a communication load in the on-vehicle network;

an acquisition unit configured to acquire first distribution information indicating a frequency distribution of the moving average calculated by the monitoring unit;

a detection unit configured to set a first threshold value based on the first distribution information acquired by the acquisition unit, and detect an abnormality in the on-vehicle network, based on the set first threshold value and on the moving average acquired by the monitoring unit at a first timing after an acquisition timing of the moving average included in the frequency distribution; and

an estimation unit configured to calculate an estimation value of the moving average at the first timing, based on the moving average acquired by the monitoring unit at a timing before the first timing, wherein

the monitoring unit calculates, as an error, a difference between the moving average at the first timing and the estimation value,

the acquisition unit further acquires second distribution information indicating a frequency distribution of the error calculated by the monitoring unit, and

the detection unit further sets a second threshold value based on the second distribution information acquired by the acquisition unit, and estimates occurrence of an unauthorized message in the on-vehicle network, based on the set second threshold value and on the error acquired by the monitoring unit at the first timing.

### [Additional Note 2]

A gateway device configured to relay messages between on-vehicle devices in an on-vehicle network, the gateway device comprising:

a monitoring unit configured to monitor transmission messages in the on-vehicle network, and calculate a moving average of time series data of a communication load in the on-vehicle network;

an acquisition unit configured to acquire first distribution information indicating a frequency distribution of the moving average calculated by the monitoring unit;

a detection unit configured to set a first threshold value based on the first distribution information acquired by the acquisition unit, and detect an abnormality in the on-vehicle network, based on the set first threshold value and on a moving average acquired by the monitoring unit at a first timing after an acquisition timing of the moving average included in the frequency distribution; and

an estimation unit configured to calculate an estimation value of the moving average at the first timing, based on the moving average acquired by the monitoring unit at a timing before the first timing, wherein

the monitoring unit calculates, as an error, a difference between the moving average at the first timing and the estimation value,

the acquisition unit further acquires second distribution information indicating a frequency distribution of the error calculated by the monitoring unit, and

the detection unit further sets a second threshold value based on the second distribution information acquired by the acquisition unit, and estimates occurrence of an unauthorized message in the on-vehicle network, based on the set second threshold value and on the error acquired by the monitoring unit at the first timing.

### REFERENCE SIGNS LIST

12 on-vehicle network
13, 14 bus
51 communication processing unit
52 monitoring unit
53 acquisition unit
54 detection unit
55 notification unit
56 storage unit
62 monitoring unit
63 acquisition unit
64 detection unit
72 monitoring unit
73 acquisition unit
74 detection unit
75 notification unit
101 gateway device
102 gateway device
103 gateway device
111 on-vehicle communication device
112 port
121 bus connection device group
122 control device
131 detection device
301 on-vehicle communication system

1-10. (canceled)

11. A detection device configured to detect an abnormality in an on-vehicle network including a plurality of on-vehicle devices, the detection device comprising:
a monitoring unit configured to monitor transmission messages in the on-vehicle network, and acquire a communication load in the on-vehicle network;
an acquisition unit configured to acquire a history of a communication load in an on-vehicle network to which the detection device belongs, or another on-vehicle network; and
a detection unit configured to detect an abnormality in the on-vehicle network, based on the history acquired by the acquisition unit and on the communication load acquired by the monitoring unit at a first timing after the history.

12. The detection device according to claim 11, further comprising:
an estimation unit configured to calculate an estimation value of the communication load at the first timing, based on the communication load acquired by the monitoring unit at a timing before the first timing, wherein
the detection unit compares the communication load acquired at the first timing by the monitoring unit with the estimation value at the first timing calculated by the estimation unit, and estimates occurrence of an unauthorized message in the on-vehicle network, based on a result of the comparison.

13. The detection device according to claim 12, wherein
when occurrence of an unauthorized message has been estimated by the detection unit, the estimation unit calculates the estimation value at a second timing after the first timing, based on the communication load acquired at a timing on or after the first timing.

14. The detection device according to claim 12, further comprising:
a notification unit configured to output first alarm information when an abnormality in the on-vehicle network has been detected by the detection unit, and output second alarm information different from the first alarm information when occurrence of an unauthorized message in the on-vehicle network has been estimated by the detection unit.

15. The detection device according to claim 11, wherein
the monitoring unit calculates, as the communication load at the first timing, a moving average of time series data of the communication load.

16. The detection device according to claim 11, wherein
the on-vehicle network to which the detection device belongs is an on-vehicle network of a target vehicle having the detection device.

17. The detection device according to claim 11, wherein
the another on-vehicle network is an on-vehicle network of a test vehicle of the same type as a target vehicle having the detection device.

18. A detection device configured to detect an abnormality in an on-vehicle network including a plurality of on-vehicle devices, the detection device comprising:
a monitoring unit configured to monitor transmission messages in the on-vehicle network, and acquire a communication load in the on-vehicle network;
an estimation unit configured to calculate, based on the communication load acquired in the past by the monitoring unit, an estimation value of the communication load to be acquired by the monitoring unit;
an acquisition unit configured to acquire a history of a difference between an estimation value and a communication load in an on-vehicle network to which the detection device belongs, or another on-vehicle network; and
a detection unit configured to detect an abnormality in the on-vehicle network, based on the history acquired by the acquisition unit, the communication load acquired by the monitoring unit at a first timing after the history, and the estimation value, of the communication load at the first timing, calculated by the estimation unit.

19. A detection method used by a detection device configured to detect an abnormality in an on-vehicle network including a plurality of on-vehicle devices, the detection method comprising:
monitoring transmission messages in the on-vehicle network, and acquiring a communication load in the on-vehicle network;
acquiring a history of a communication load in an on-vehicle network to which the detection device belongs, or another on-vehicle network; and
detecting an abnormality in the on-vehicle network, based on the acquired history and on the communication load at a first timing after the history.

20. A detection method used by a detection device configured to detect an abnormality in an on-vehicle network including a plurality of on-vehicle devices, the detection method comprising:
monitoring transmission messages in the on-vehicle network, and acquiring a communication load in the on-vehicle network;
calculating an estimation value of the communication load, based on the communication load acquired in the past;
acquiring a history of a difference between an estimation value and a communication load in an on-vehicle network to which the detection device belongs, or another on-vehicle network; and
detecting an abnormality in the on-vehicle network, based on the acquired history, the communication load at a first timing after the history, and the estimation value of the communication load at the first timing.

21. A non-transitory computer readable storage medium storing a detection program used in a detection device configured to detect an abnormality in an on-vehicle network including a plurality of on-vehicle devices, the detection program causing a computer to function as:
a monitoring unit configured to monitor transmission messages in the on-vehicle network, and acquire a communication load in the on-vehicle network;
an acquisition unit configured to acquire a history of a communication load in an on-vehicle network to which the detection device belongs, or another on-vehicle network; and
a detection unit configured to detect an abnormality in the on-vehicle network, based on the history acquired by the acquisition unit and on the communication load acquired by the monitoring unit at a first timing after the history.

22. A non-transitory computer readable storage medium storing a detection program used in a detection device configured to detect an abnormality in an on-vehicle network including a plurality of on-vehicle devices, the detection program causing a computer to function as:
a monitoring unit configured to monitor transmission messages in the on-vehicle network, and acquire a communication load in the on-vehicle network;
an estimation unit configured to calculate, based on the communication load acquired in the past by the monitoring unit, an estimation value of the communication load to be acquired by the monitoring unit;
an acquisition unit configured to acquire a history of a difference between an estimation value and a communication load in an on-vehicle network to which the detection device belongs, or another on-vehicle network; and
a detection unit configured to detect an abnormality in the on-vehicle network, based on the history acquired by the acquisition unit, the communication load acquired by the monitoring unit at a first timing after the history, and the estimation value, of the communication load at the first timing, calculated by the estimation unit.
